(19) United States
(12) Patent Application Publication
(10) Pub. No.: US 2025/0331072 A1
(43) Pub. Date: Oct. 23, 2025

(54) METHODS AND SYSTEMS FOR DETERMINING RESONANT FREQUENCIES

(71) Applicant: Skalene Limited, Cambridge Cambridgeshire (GB)

(72) Inventors: Julian WHITE, Cambridge Cambridgeshire (GB); Martin HORROD, Cambridge Cambridgeshire (GB)

(73) Assignee: Skalene Limited, Cambridge Cambridgeshire (GB)

(21) Appl. No.: 18/865,697

(22) PCT Filed: May 25, 2023
(86) PCT No.: PCT/GB2023/051366

§ 371 Date: Nov. 14, 2024

(30) Foreign Application Priority Data
May 25, 2022 (GB) 2207682.2

(51) Int. Cl. H05B 6/10; A24F 40/465; A24F 40/57; H05B 6/06

(52) U.S. Cl. CPC H05B 6/108; A24F 40/465; A24F 40/57; H05B 6/06

(57) ABSTRACT

A method comprising: providing an LCR circuit comprising an inductive element and a capacitor, and applying a voltage to the LCR circuit, wherein the applied voltage induces a response between the capacitor and the inductive element of the LCR circuit, determining a plurality of resonant frequencies for the response at a plurality of times, respectively: generating an output signal of the response and selecting a resonant frequency from the plurality of resonant frequency based on the output signal wherein setting the frequency of the applied voltage is selected dependent on the selected resonant frequency and then repeating the steps outlined above.

### TECHNICAL FIELD

Aspects of the present invention generally relate to methods and system for determining resonant frequency, more specifically using inductive elements in aerosol generating devices.

### BACKGROUND

Aerosol generating devices are known. For example, tobacco heating devices heat an aerosol generating substrate such as tobacco to form an aerosol by heating, but not burning, the substrate.

Common devices use inductive heaters to create an aerosol from a suitable medium which is then inhaled by a user. Often suitable media require significant levels of heating prior to generating an aerosol for inhalation. As such, the heaters of such devices reach high operational temperatures. User safety of such devices is paramount.

To date, many systems have been devised to measure the temperature in inductive heaters by observing a change in resonant frequency, fᵣₑₛ. Often, they rely on directly measuring the fᵣₑₛ of the tank circuit using an external signal, and then looking at the response of the circuit using digital counters to accumulate pulses over a fixed period, or interval timers that measure the gap between individual pulses.

WO2020/260884A1 describes inducting heaters used in aerosol generating devices and methods of measuring temperature. There is an ongoing need to provide improved methods and systems for such devices.

### SUMMARY

The present invention provides systems and methods for estimating the resonant frequency using inductive elements for inductively heating a susceptor; the resonant frequency may be then employed as a proxy variable for the temperature of, for example, the susceptor within an induction heater system. The systems and methods use an Estimated Resonant Frequency (ERF) as it is not possible to know the Actual Resonant Frequency (ARF) at any given time point. The systems and methods described may use multiple factors, including the discrete array of measurements and an approximation of the Least Square fitting, to generate an ERF. The ERF is highly correlated with the ARF and is time responsive so that the overall system can accurately control rapid temperature fluctuations.

The susceptor may be included as part of a removable consumable. The susceptor represents an element able to be heated by induction heating, a process well known in the art. In preferred embodiments, the induction heater is designed such that the only element showing significant change in its electrical properties due to heating is the susceptor and not the surrounding heater mechanism.

In a first independent aspect, there is provided a method according to claim 1. The method further comprises setting the frequency of the applied voltage to a value that is representing an ERF based on the output signals to estimate the ARF and repeating the steps of the method according to the first independent aspect. Accordingly, the method is an iterative method. Advantageously, signal averaging over time can be used to increase system performance.

In a dependent aspect, the output signal comprises a voltage (or current) signal, the method further comprising determining a maximum value for the voltage (or current) signal, wherein the ERF is selected to be the ARF of the plurality of frequency corresponding to the determined maximum value. Accordingly, the method estimates the ARF of the composite induction heater system by sampling a series of excitation frequencies and monitoring the output in response, such as the current flowing in the circuit. For example, a value for the frequency at which the peak system voltage (current) occurs represents the ERF of the system, assuming that the first differential of the response curve is roughly linear.

In a further dependent aspect, the step of determining a maximum value comprises fitting a polynomial function to the output signal data. In a further dependent aspect, the method further comprises minimising an order of the polynomial function using a Coefficient of Determination (CD). Alternatively, determining a maximum value comprises using a Least Squares Approximation method.

In a further dependent aspect, the iterative method comprises in a second iteration setting the frequency to a value above the ERF and, in a third iteration, setting the frequency to a value below the ERF. Advantageously, this can lead to limiting the rate of charge the power supply and circuit have to source/sink, which increases the overall efficiency and reduces the electrical stress on the device, prolonging its life.

In a dependent aspect, selecting an ERF uses a peak detector circuit (PDC) comprising a PDC capacitor, the method further comprising the steps of:
charging the PDC capacitor during a sample time period;
measuring a plurality of voltages comprises in the output signal, and calculating an average value of the plurality of voltages over the sample time period;
discharging the PDC capacitor; and setting the frequency of the applied voltage to the ERF.

In a dependent aspect, the method further comprises inductively heating a susceptor using said inductive element, to aerosolise a substance in a heating mode of operation.

In a dependent aspect, the output signal is used to provide a temperature measurement for the susceptor. In a further dependent aspect, providing a temperature measurement comprises determining the electrical resistance of the susceptor. Accordingly, the frequency value is directly converted to a temperature value, or can be used to find a value for the resistance of the secondary conductor represented by the susceptor.

In a dependent aspect, the method comprises repeating the steps of the method according to the first independent aspect to provide a plurality of ERFs, determining a maximum value of the ERF, and, if the maximum value of the ERF is within a predetermined range, setting the frequency of the applied impulse to the maximum value. In a further dependent aspect, the method further comprises repeating the steps above to ensure that the set ERF is within the predetermined range.

In a dependent aspect, the method further comprises determining a change in the ERF (for example based on changes or shifts in the output signal). By detecting and quantifying shifts in actual resonant frequency (ARF) and/or response amplitude, an induction heater device is able to simultaneously heat the susceptor and detect the temperature it has reached through the circuit, dispensing with the need for external sensors such as thermocouples or thermistors.

In a dependent aspect, selecting the ERF comprises determining a change in the circuit resistance, the method further comprising determining a susceptor temperature. Advantageously this allows for susceptors made out of aluminium foils which are multiple skin depths thick and/or other common metals such as nickel or (stainless) steel, allowing for low values of the Quality Factor (QF) which represents low losses in the system.

In a further dependent aspect, there is provided a method of controlling the temperature of said susceptor in real time, using methods as defined herein. Being able to measure in real time a parameter that reflects the temperature of the secondary conductor can then be advantageously used as the control variable in the closed loop temperature control system.

In an example, the method allows a passive tubular conductive susceptor with no modifications to act as the temperature sensor for the heating process. This leads to a higher performance heater with more accurate temperature determination with better reliability at a significantly lower overall cost. This allows it to be replaceable should it become contaminated and/or damaged during use. In addition, the method can be used to manage heating in a range of materials, in the form of tubes, plates and rods that may or may not give off particulates, aerosols or vapours.

In a further independent aspect, there is provided a system according to claim 16.

In a dependent aspect, the voltage generator comprises a switching arrangement for generating impulses by switching between positive and negative voltage sources. In further dependent aspects, the switching arrangement comprises a H-bridge, preferably a half H-bridge (HHB). The function of a H-bridge is to efficiently convert direct electrical current into an alternating current.

In a dependent aspect, the voltage generator comprises a damping resistor and turn-off diode. Advantageously, the inclusion of such networks makes the signal more smooth and prevents voltage spikes.

In a dependent aspect, the inductive element comprises a flat strip conductor, for example made out of copper or other suitable metal. For example, the susceptor may be made of aluminium.

In a dependent aspect, the susceptor is a helical wound susceptor. In a further dependent aspect, the susceptor has a conical shape.

The inductive element may be thought of as a first circuit of a transformer, while the susceptor forms the second circuit of the same transformer. In a dependent aspect, an electrical connection is provided around the second circuit of the transformer (i.e. the susceptor). The electrical connection may be direct or comprising a capacitor.

In a dependent aspect, the system comprises a peak detector circuit (PDC) for determining a voltage maximum value from a plurality of voltages in the output signal. In a further dependent aspect, the PDC comprises a unity-gain Op-Amp (OA). In a further dependent aspect, the PDC comprises a switch having an impedance switchable between ˜0 and ∞Ω. This reduces the time for the voltage to reach an equilibrium during a sample time period. In a further dependent aspect, the PDC comprises a ceramic capacitor, preferably made of COG/NPO material; this increases stability over time and ambient temperatures. In a further dependent aspect, the PDC comprises a bipolar field effect transistor, preferably with low on resistance and a very high off resistance.

In some embodiments, a current sensor is provided for measuring a current passing through the inductive element. In further embodiments, a control module is provided for determining a performance of said system based on the output signal.

In a further aspect there are provided computer-readable instructions which, when executed by a computing apparatus, cause the computing apparatus to perform the method as described according to the first independent aspect.

In a further aspect, there is provided an aerosol provision system for generating aerosol from an aerosolisable material, the aerosol provision system comprising a system including any of the features of the system according to the independent aspect described above, wherein the aerosol provision system (or delivery system) is configured to perform an action in response to receiving an output signal from the output circuit. It will be appreciated that systems and methods according to the invention may be used in various suitable delivery systems.

An example of the susceptor arrangement for receiving a consumable and for use in an aerosol provision system, wherein the susceptor arrangement is helically wound.

In a further preferred example, the susceptor arrangement is made of aluminium.

An example of the susceptor arrangement, whereby the susceptor is conical, preferably have a cone angle of 1-10°. As the consumable is typically cylindrical, when the consumable is pushed fully inside the susceptor, the lower half of the consumable will be in contact with the susceptor, enabling good thermal contact.

Using a helical wound structure is advantageous, as it provides a way to fabricate a controllable shallow angle cone that is as strong as a cylinder.

Further dependent aspects are provided in the dependent claims which may be applicable to each one of the independent aspects.

### BRIEF DESCRIPTION OF THE DRAWINGS

Examples of the present invention will now be described with reference to the accompanying drawings, where:

FIG. 1 is a diagram of a LCR “tank circuit”;

FIGS. 2(a) to (c) are plots showing relationships between driving voltage and current in a LCR tank circuit;

FIGS. 3(a) and 3(b) are plots showing outputs according to example embodiments of the invention;

FIGS. 4(a) to (c) show examples of circuit layouts;

FIG. 5 shows an example induction heater which may be used in embodiments of the invention;

FIG. 6 shows a circuit which may be used in embodiments of the invention;

FIGS. 7(a) and 7(b) show exemplary switching arrangements which may be used in embodiments of the invention;

FIG. 8 illustrates an example circuit according to an embodiment of the invention;

FIGS. 9(a) and (b) show examples of Peak Detector Circuits (PDC) which may be used in embodiments of the invention;

FIG. 10 is a plot showing an example measurement sequence of a PDC;

FIG. 11 is a flow chart showing an algorithm in accordance with an example embodiment of the invention;

FIGS. 12(a) and (b) show exemplary outputs of Pulse With Modulation (PWM) systems;

FIGS. 13(a) and (b) illustrate the construction of a helical wound susceptor which may be used in embodiments of the invention;

FIG. 14 is a plot showing comparative resonance profiles for an example helical wound susceptor, at five different temperatures;

FIG. 15 is a plot showing a more detailed profile of the 200° C. curve shown in FIG. 14;

FIG. 16 is a plot showing examples calculated values of the foil temperature of a helical wound susceptor as a function of as a function of the estimated resonant frequency of the system;

FIG. 17 is a plot illustrating an example parametric fit used for closed-loop control of the temperature profile in an induction heater;

FIG. 18 is a plot illustrating the origin of the peak voltage in an example series tank circuit near resonance and how its related to the circuit's resistance; and

FIG. 19 is a plot showing an example calibration curve of susceptor temperature versus measured peak ADV voltage.

### DETAILED DESCRIPTION

### 1. Finding Resonant Frequencies in Series LCR Tank Circuits

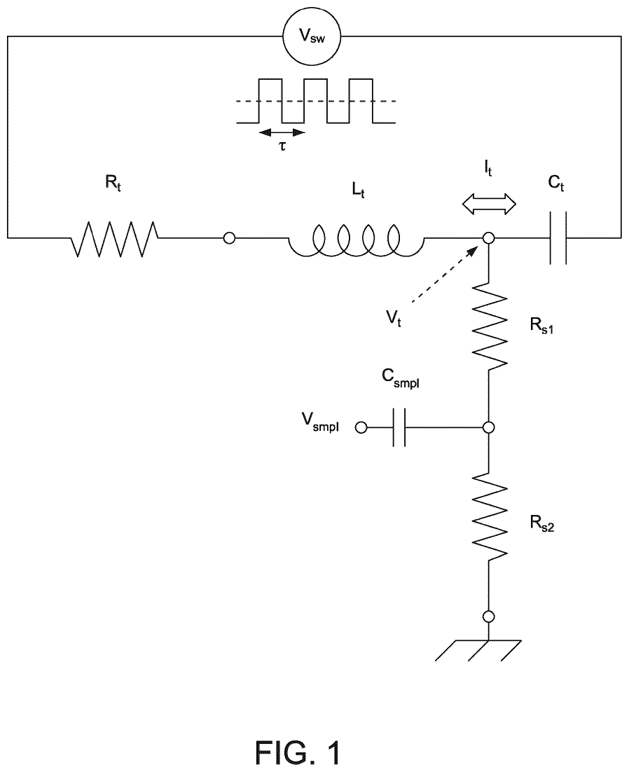

FIG. 1 illustrates an example LCR “tank circuit” comprising a resistor (Rₜ), inductor (Lₜ) and capacitor (Cₜ) connected to a source of voltage (V_{sw}) oscillating as a bipolar square wave with a frequency fd (=1/t), where bipolar refers to the output voltage symmetrically oscillating between positive and negative over one cycle. V_{sw} will generate an Alternating Current (AC) in the tank circuit. Even if a circuit only comprises inductors and capacitors, there are losses in the circuit due to finite resistances of component leads and tracking on the printed circuit boards which manifests as a resistance, shown as Rₜ.

As is well documented in the art (https://en.wikipedia.org/wiki/RLC_circuit) this arrangement has the property that if the frequency is an ARF (fᵣₑₛ)=1/(2π√(LₜCₜ)), then the current |Iₜ| through the circuit is maximised. The ARF (fᵣₑₛ) represents the frequency where the energy stored in the inductor Li as a magnetic field is the same as the capacitor's Cₜ electrostatic field. As the circuit oscillates, the two components swap this energy every half cycle, leaving just the resistor to modulate the current generated by V_{sw}. From all respects any effects caused by the presence of Li and Cₜ disappear and the Iₜ follows V_{sw}, where the former can be calculated from the equation: Iₜ=V_{sw}/Rₜ.

The resonance properties of a tank circuit also depend on the amount of loss, governed by the value of Rₜ relative to Li and Cₜ. To gauge the effect of this, Q, or Quality Factor (QF) can be defined as Q=(1/R)√(L/C). The QF may be described as the measure of loss in the system which can be thought of as the ratio of the energy stored in the reactive elements (L; and c) versus the amount that is lost every full cycle of the driving square wave. Thus, Q=100 means that ˜1% is lost per cycle.

In addition to Rₜ, Lₜ and Cₜ shown in FIG. 1, the system comprises a circuit ‘tapping’ off at the intersection of the Cₜ and Lₜ, comprising two series resistors Rₛ₁ and Rₛ₂ and a low value capacitor, Cₛₘₚₗ, preferably in the pico-Farad range which form a classic potential divider where Vₛₘₚₗ=Vₜ·Rₛ₁/(Rₛ₁+Rₛ₂), wherein Vₜ is the voltage at the node formed where Lₜ and Cₜ are connected. By changing the values of Rₛ₁ and Rₛ₂, the magnitude of Vₛₘₚₗ can be effectively adjusted from 0 to Vₜ. The presence of Cₛₘₚₗ will block any direct current flowing from the tank circuit meaning that Vₛₘₚₗ will be a symmetric sine-wave, centred around GND (ground voltage).

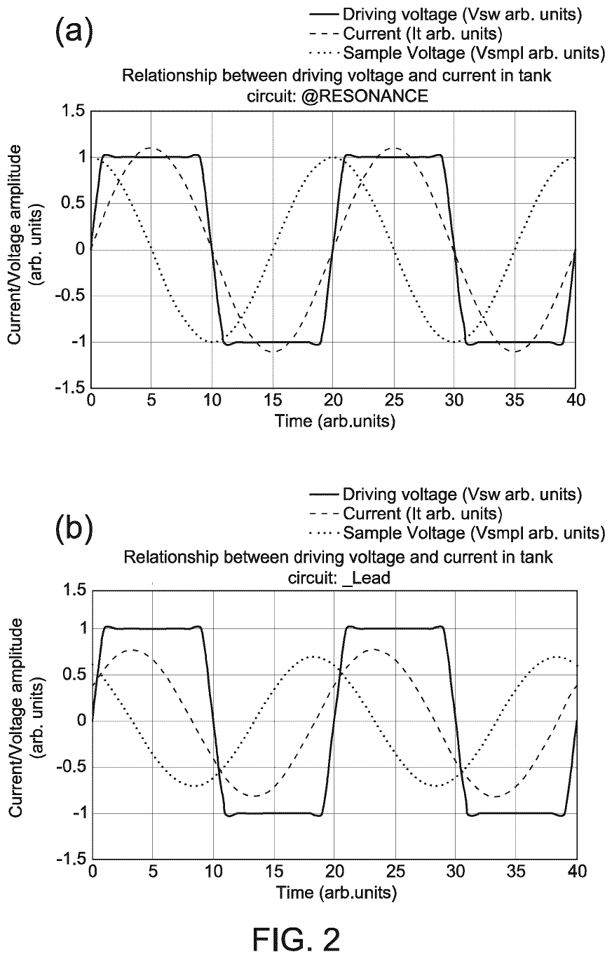

FIG. 2(a) shows an example representation of a V_{sw} plotted against Iₜ and Vₛₘₚₗ for an exemplary value of T=20. In this example, despite V_{sw} having a square profile, the current flowing in the circuit appears as a sine wave due to the band-pass frequency filtering properties of the LCR circuit, which attenuates the higher order Fourier terms in the square wave. The effectiveness improves as the value of Q increases.

If the driving frequency fd is set to ARF (fᵣₑₛ), the peaks and troughs in Iₜ occur at τ/4 and 3τ/4 respectively when referenced to the driving voltage V_{sw}. To obtain a finite voltage reading Vₛₘₚₗ has to measured relative to earth (GND). As the only way this can happen is for Cₜ to be fully charged and Iₜ=0, then it will be offset by 90° to Iₜ (τ/4). From the plot shown in FIG. 2(a), V_{sw} and Iₜ are in phase throughout the full cycle. Due to this shift, when |Iₜ| is a maximum, Vₛₘₚₗ=0 and when |I: |=0, |Vₛₘₚₗ| is at a maximum. Therefore, in this case the criterion for Vₛₘₚₗ means that at resonance, the zero crossing points of Vₛₘₚₗ are located at τ/4 and 3τ/4, respectively.

FIGS. 2(b) and 2(c) illustrate what happens when fd does not match ARF (fᵣₑₛ), due to changes in Lₜ, Cₜ or Rₜ values. Referring to FIG. 2(b), when f_{d}<fᵣₑₛ, the impedance of Cₜ dominates and thus the current leads the voltage, similar to the situation of a pure capacitance being connected across an alternating supply. Likewise, FIG. 2(c) illustrates the behaviour of the parameters when fd >fᵣₑₛ. In this case the inductor Lₜ dominates, causing the current to lag the driving voltage.

In both cases of FIGS. 2(b) and 2(c), the profiles of V_{sw} and Vₛₘₚₗ are not synchronised and, moreover, the amplitudes of Vₛₘₚₗ are less than that shown in FIG. 2(a). For an untuned tank circuit, if V_{sw} and Vₛₐₘₚₗ are visualised on an oscilloscope, then as fa approaches fᵣₑₛ from either direction (high frequency to low or vice versa) the amplitude of Vₛₘₚₗ increases relative to V_{sw}. When f_{d}=fᵣₑₛ, Vₛₘₚₗ reaches a maximum. This is because resonance occurs when the complex impedances of Cₜ and Li become equal, and, because Cₜ and Lₜ are 180° out of phase, they cancel each other out, leaving only the impedance of Rₜ.

Accordingly, in this example it is possible to use Vₛₘₚₗ to determine ARF (fᵣₑₛ). Specifically, if the circuit is excited by an array of N discrete frequencies with ARF (fᵣₑₛ) roughly in the middle of the array, then an averaged value of Vₛₘₚₗ may be obtained and plotted for each frequency increment. For best results, each Vₛₘₚₗ data point preferably has a small variance relative to its amplitude, which may require the parameter to be measured many times and the average value derived.

Despite this level of accuracy this numerically derived value can never be the true value of the ARF. As such, from this point forward this quantity will be referred to as the ERF and the stated values of ERF and fᵣₑₛ will be treated as being identical and interchangeable.

An method of estimating the peak value of the data (ERF) is to fit a polynomial curve to the data set, in the following form that relates Vₛₘₚₗ to the excitation frequency, fd in the form:

$${V}_{smpl} = {af}_{d}^{n} + {bf}_{d}^{n - 1} + {cf}_{d}^{n - 2} + … + constant \qquad ( 1 )$$

Although a polynomial fit works well, it will be appreciated that other mathematical functions based on functions such as logarithmic, exponential and trigonometric can also be used. Moreover, there are many ways of fitting a set of data to a mathematical function; in this example, the method of Least Squares Approximation (LSA) is used (https://en.wikipedia.org/wiki/Least_squares).

If Eq. (1) is differentiated to give the following:

$${dV}_{smpl} / {df}_{d} = {naf}_{d}^{n - 1} + ( n - 1 ) {bf}_{d}^{n - 2} + ( n - 2 ) {cf}_{d}^{n - 3} + … \qquad ( 2 )$$

The value of f_{d} where Vₛₘₚₗ is at a maximum corresponds to f_{d}=fᵣₑₛ can be found from the relation:

$${dV}_{smpl} / {df}_{d} = {naf}_{res}^{n - 1} + ( n - 1 ) {bf}_{res}^{n - 2} + ( n - 2 ) {cf}_{res}^{n - 3} + … = 0 \qquad ( 3 )$$

To find ERF (fᵣₑₛ), the roots of Eq. (3) have to be found. This can be done in number of ways known in the art (https://en.wikipedia.org/wiki/Root-finding_algorithms).

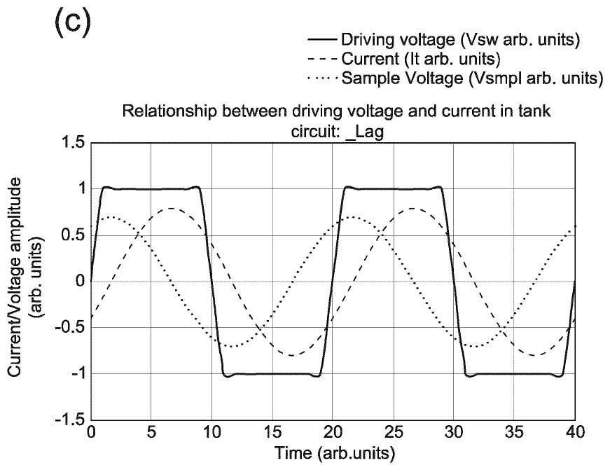

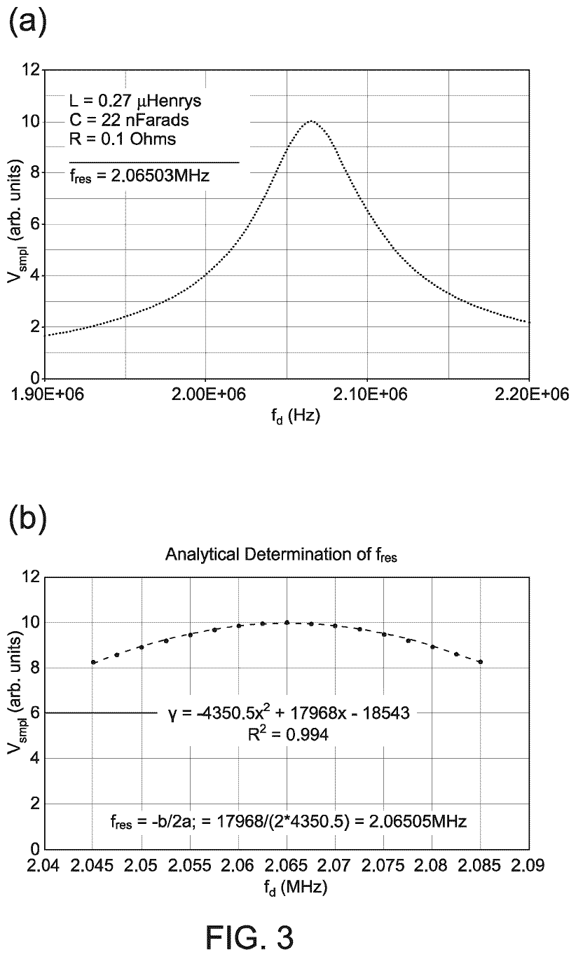

FIGS. 3(a) and 3(b) illustrate the use of this technique. FIG. 3(a) shows the behaviour of the current flow through a series LCR circuit with the values shown around fᵣₑₛ=2.07 MHz, enumerated at discrete frequencies spaced at 2.5 KHz. FIG. 3(b) shows further detail over a narrower window of 40 KHz either side of the fᵣₑₛ. Because the format of the peak is relatively symmetric, a good fit may be achieved for a second order polynomial as illustrated by the dashed line of the form:

$${V}_{smpl} = {af}_{d}^{2} + {bf}_{d} + c \qquad ( 4 )$$

To find the value of fᵣₑₛ:

$${dV}_{smpl} / {df}_{d} = 2 {af}_{d} + b = 0 \qquad ( 5 )$$

Resulting in:

$${f}_{res} = - b / 2 a \qquad ( 6 )$$

In this case, even though the points are generated by an equation, the fit line (dashed) is derived using the least squares method and is therefore independent. Using the coefficients and the methodology outlined, Eqs (4), (5) & (6) produce an overall value for fᵣₑₛ that agrees with the calculated value to 5 significant figures. Iₜ should be noted that an increase in the order of the polynomial chosen will often increase the accuracy of the derived fᵣₑₛ, but this will come at an increased cost in computational overhead in deriving the number of polynomial coefficients and root finding, whose overhead is non-linear. Thus, an effective strategy is to use the lowest order that gives an acceptable Coefficient of Determination (CD=R²; see https://en.wikipedia.org/wiki/Coefficient_of_determination for further details). Iₜ will be appreciated that any viable methodologies for fitting the polynomial coefficients and finding the roots of the result can be utilised. Once ERF (fᵣₑₛ) has been selected by the above method, then the scan parameters can be reset using this value as the central point of the scan and the process can then re-commence.

As described above, the process can be automated and programmed into a small microprocessor for example, to achieve a real-time feedback mechanism. Once the resonance condition is satisfied, the system can continue to monitor should the component values shift or there are any other external factors might change the value of fᵣₑₛ. If the system is run continuously over time, signal averaging can be used to produce better performance.

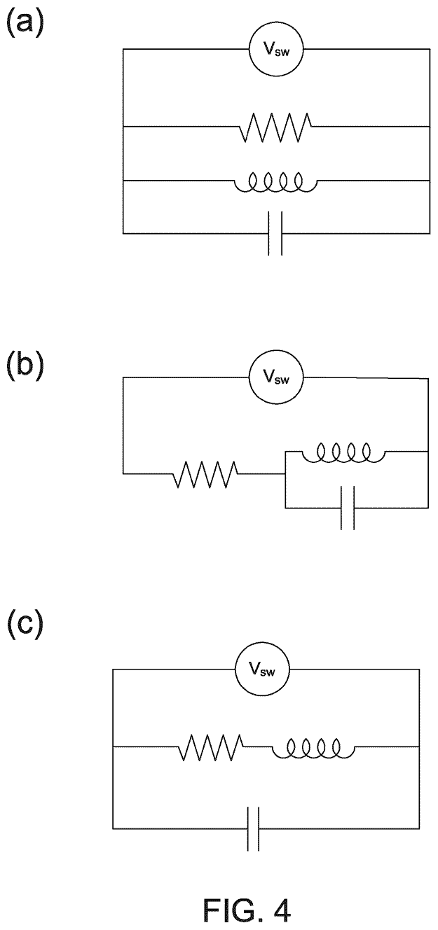

Moreover, this method will work equally well for any generalised form of LCR circuit layout, three examples of which are illustrated in FIG. 4. Iₜ should be noted that the topologies shown are a subset of the possible LCR combinations, including both series and parallel connections of the inductor, capacitor and resistor of which there are many. In general, parallel topologies will maximise the circuit impedance of the circuit, minimising the current through the network at fᵣₑₛ. Moreover, if multiple component classes are added, e.g. two inductors, a capacitor and resistor along with the ability to change the value of the components then there an infinite number of options, although only a small subset will be useful in practice.

### 2. Resonant Inductive Heater Circuits

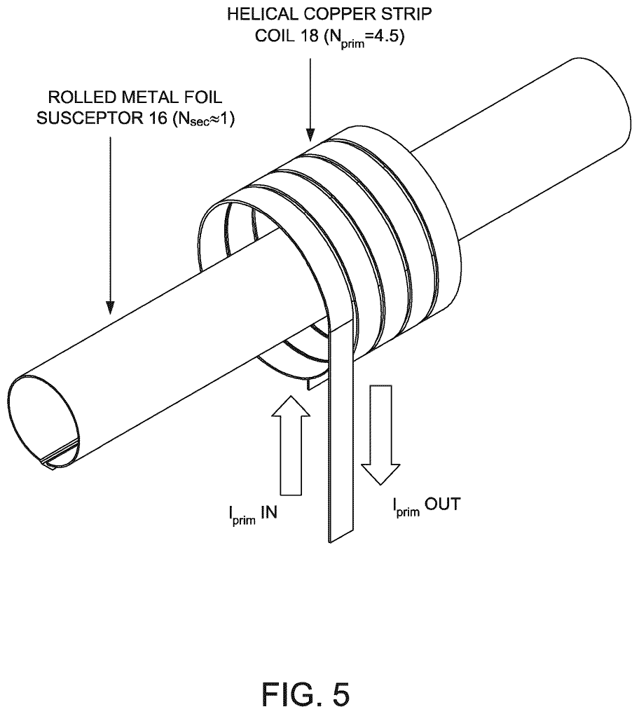

One use of the above described technique is in inductive heaters, an example of which is shown in FIG. 5. FIG. 5 shows an exemplary induction heater, where L is formed as a combination of a coil 18 wrapped around a cylindrical sheet of metal such as aluminium or stainless steel referred to as the susceptor 16. In this way Lₜ can be viewed as the primary side 18 of a transformer with an inductance of Lₚᵣᵢₘ and the susceptor 16 acting as the secondary side of the transformer with an inductance of L_{sec}. In this case Lₚᵣᵢₘ has a number of turns, Nₚᵣᵢₘ, and L_{sec}, configured as it is shown in this example, has a single turn.

In order to maximise susceptor heating, the susceptor 16 is preferably chosen to be resistive either by composition, form or both (e.g. metal choice and thickness) such that an induced current flowing in Lₚᵣᵢₘ will induce a significant current in the susceptor 16 that, in turn, will generate significant ohmic heating.

The example shown in FIG. 5 comprises a rectangular cross-section conductor 18 with a high aspect ratio in terms of width to thickness, in order to make full use of the coil's ability to carry current. This is because, due to an electromagnetic effect termed as the skin effect (https://en.wikipedia.org/wiki/Skin effect) an AC of any frequency is effectively restricted to flow on the surface of the conductor 18 and down to depth termed as the skin depth δ. In practical realisations of the inductive heater, the 4.5 turn coil 18 is made of copper and for an AC of 2 MHz, δ˜50 μm. For a circular cross section wire, 1 mm in diameter with a total wire cross section of 0.79mm² the AC will effectively travel within a tube of copper representing only 19% of the total copper present (=0.15mm²). Alternatively, if the primary coil was instead preferably fabricated in embodiments according to the invention from a copper strip 2.5 mm wide/100 μm thick, ˜100% of the copper would take part in the conduction, corresponding to a cross sectional area of 0.25mm². Comparing this to the circular case, the strip implementation simultaneously reduces resistance losses by 62%, whilst only needing 31% of the copper. As such, a Flat Strip Conductor (FSC) 18 is both more energy and resource efficient to form the primary coil from a metal strip of thickness 28 than using circular cross section wires. Iₜ should be noted that many induction coils utilise a special would wire usually referred to as a Litz Wire (LW) (https://en.wikipedia.org/wiki/Litz wire). Although LWs are used in many applications, their use in consumer products is cumbersome and costly when compared with FSC, and they are only manufactured by a relatively small number of suppliers.

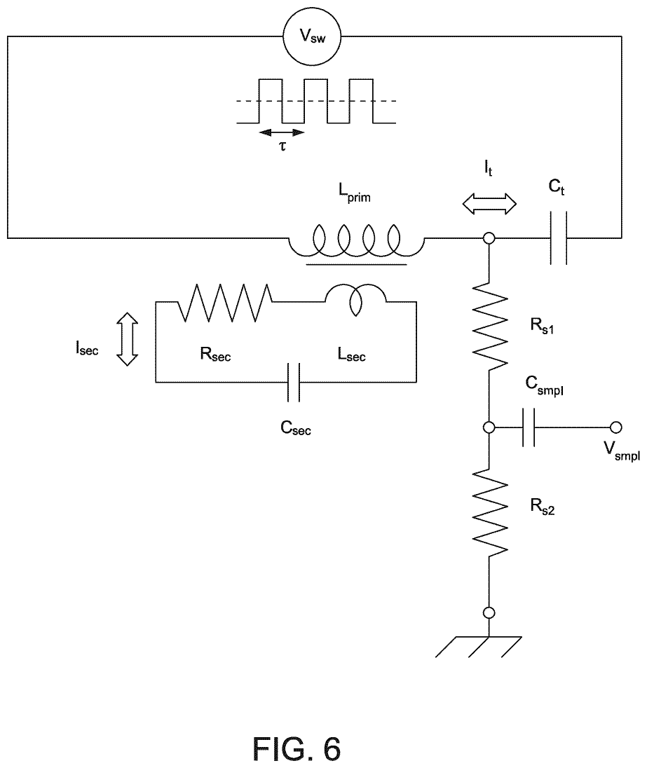

FIG. 6 shows the equivalent circuit that this arrangement gives rise, wherein R_{sec} is the Ohmic component of the secondary impedance, and Z_{sec} is the inductance of the secondary impedance. Using complex notation, Z_{sec}=R_{sec}+j (X_{Lsec}+X_{Csec}), where X_{Lsec}=jω L_{sec}, X_{Csec}=−j/ω C_{sec} and j=v−1. In order to maximise the energy dissipated in R_{sec}, it is necessary for the complex component of the impedance to cancel out, which in turn maximises the electrical current through the circuit, implying the circuit needs to be driven at fᵣₑₛ=1/2π√(L_{sec}C_{sec}). Due to the transformer equation, the impedance Z_{sec} in the susceptor 16 as seen within the primary circuit is magnified Nₚᵣᵢₘ² (see e.g. http://hyperphysics.phy-astr.gsu.edu/hbase/magnetic/refload.html).

The purpose of the susceptor 16 is to extract energy from the primary circuit, turning it into heat which substantially raises the susceptor temperature, usually by approximately 200° C., so that, in turn, it can heat an item placed within it to a similar temperature. Using the above relationship, if Lₚᵣᵢₘ is composed of 4 turns it will increase the nominal value of Z_{sec} 16 times. Because the aim is to minimise the loss in the primary circuit and the transformer, a well-designed circuit would only dissipate the available energy in the secondary circuit. As such, because of the transformer magnifying the R_{sec}, Rₜ has been omitted from FIG. 6. Referring back to FIG. 1, at this level of analysis, the combination of R_{sec} and Lₚᵣᵢₘ/L_{sec} would appear as the equivalent of the Rₜ and Li respectively.

When a susceptor 16 heats up, the ARF changes. In practice there are a number of potential reasons for this effect, such as the increase in R_{sec} as the susceptor heats. Overall, this effect has a number of consequences, including;
If f_{d} initially=ERF, but ERF shifts due to heating and f_{d} is left unchanged, the efficiency of transferring energy to the susceptor 16 decreases, slowing the heat up rate and possibly causing thermal stress on the primary circuit.
If this change is tracked during the heat up phase, its value can often be used as a proxy for the temperature of the susceptor 16 (see section 6 below), avoiding use of discrete temperature sensors having to be attached and monitored. Thus, being able to wirelessly measure ERF during heating (and cooling) has a number of benefits for managing an induction heater.

Referring to FIG. 6, to provide sufficient current to heat the susceptor 16 forming the secondary circuit, an electrical continuity around the secondary circuit is provided, which can be, for example:
A direct connection with a wire or similar between the left-hand-side (LHS) terminal of R_{sec} and the right-hand-side (RHS) terminal of L_{sec}. This will work for I_{sec} at any frequency including direct (non-oscillating) currents. As an example, this form of connection is found in domestic hob induction heaters.
Alternatively, for alternating currents, a capacitor can be provided instead of the wire. Preferably, the capacitor is of sufficient size such that the peak voltage generated by I_{sec} across the plates does not exceed the dielectric strength of the insulation between the plates. If not, both the efficiency of susceptor heating may be impaired and/or electrical arcing might occur which will damage the structure of the capacitor, thereby affecting the overall efficiency of energy transfer between the primary and secondary circuit.

To achieve a sufficient level of heating within the secondary circuit, it needs to have a minimum admittance value to allow sufficient power to be transferred from the primary circuit to the secondary circuit. If there is negligible ohmic or capacitive connectivity around the circuit, preventing a sufficient magnitude of I_{sec} to flow, the heating of the susceptor 16 will be restricted or even prevented.

### 3. Driving the Tank Circuit

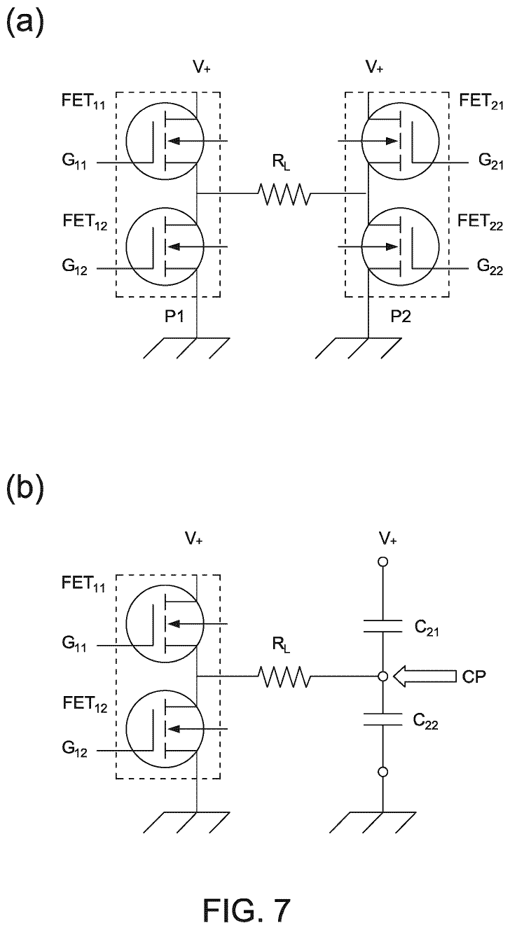

In FIG. 1, V_{sw} is defined as a bipolar square wave generator being able to supply sufficient current for heating the susceptor 16. FIG. 7(a) shows a circuit for achieving this in the form of a switching arrangement defined in the art as a H-Bridge (HB) (see https://en.wikipedia.org/wiki/H-bridge and https://ieeexplore.ieee.org/document/5411854). The function of a HB is to efficiently convert direct electrical current into an alternating current, albeit with a bipolar square wave profile with an array of transistors, being synchronously switched on/off to produce a bipolar square wave. One of the most common uses for the HB is to drive electric motors, where four transistors can efficiently control both the rotation direction and speed of the motor using a carefully synchronised set of control pulses being sent to the bases (or gates) of the transistors.

Referring to FIG. 7(a), what is termed as the ‘Full-H Bridge’ (FHB) consists of two pairs (P1/P2) of Field Effect Transistors (FET), FET11/FET12 and FET 21/FET22, with each pair connected to a DC power rail (V+) and GND. As shown the FHB manages energy supply to the resistive load (R_{L}) connected across the midpoint of the transistor pairs.

In this example, the FETs are n-channel devices, but p-channel devices could also be used, as could p- and n-channel devices in the same package. Iₜ should be noted that other transistor technologies such as bipolar devices can also be made to work equally effectively in this application. In practice, the pairs are fabricated on the same piece of semiconductor so they have a similar response to the level of voltage applied to the gate connections (Gxx) and internal heating whilst switching large currents. By careful design and perhaps component matching, single transistor packages could replicate the functions described below but would inevitably be more expensive and have a bigger footprint.

To create an oscillating voltage through R_{L}, for the first half cycle of the oscillation period, a +ve voltage is applied to gates G11 and G22 creating a low resistance path (˜0.01 Ω) whilst connecting G12 to ground and G21 to the right-hand side of R_{L} which puts them into high impedance, measured in GΩ. This will cause current to flow from P1 to P2 through R_{L}. For the second half cycle, a +ve voltage is applied to G21 and G12 whilst connecting G11 to the left-hand side of R_{L} and G22 to ground. This will induce current to flow from P2 to P1, reversing the current through R_{L}. The above processes are then repeated to create a continuous bipolar square profile current through R_{L}. A characteristic of the FHB is that the voltage swing is +V with a magnitude of |2V|.

Although the circuits can be fabricated from relatively simple and small devices most of which are similar in size to the head of a match-head, the FHB is a relatively complex circuit, with duplicated components on either side of R_{L}, and each FET pair needing independent but synchronised signals to ensure that the alternating current through R_{L} remains symmetric. Furthermore, so that energy is not wasted and the FETs are not damaged due to a phenomenon termed as Shoot-Through (ST) the four gate signals have to be carefully timed relative to each other using what is termed as a “dead band”, which adds complexity (http://www.irf.com/technical-info/appnotes/an-1032.pdf), as it has to be controlled both between the transistors within a package and also between the two packages.

To counter these issues, it is possible to use a simplified system as shown in FIG. 7(b) that uses only half the components in the FHB which is termed as a Half H-Bridge (HHB), as shown in FIG. 7(b). On the right-hand side, P2 is replaced by two capacitors in series, C₂₁ and C₂₂ with R_{L} coupled to their Common Point (CP). The capacitors can be of any value, but if R_{L} is replaced by a reactive load Z_{L}, then it is beneficial if their capacitance is orders of magnitude greater of any capacitive component of Z_{L}, with maybe an upper limit governed by size and cost. Preferably the capacitors are of the multi-layer ceramic capacitor type denoted as X7R or Y5V. For a purely DC voltage the voltage across C₂₁ and C₂₂ is dropped evenly giving a voltage of ½V+at CP. Due to the behaviour of capacitors, if there is also any component of AC in the signal then CP will be at 0V/GND potential. For this exemplary configuration, as the HHB has no DC component, CP is always at 0V.

To generate AC current, if a +ve voltage is applied to G₁₁ and G₁₂ is connected to GND in the first half cycle, then current will pass from V+, through FET11, and R_{L}, then into CP mediated by C₂₂. In the following half cycle, if G₁₁ is connected to the left-hand side of R_{L} and a +ve voltage is applied to G12, a current will pass through C₂₁, through R_{L} and down to GND via FET12. From the perspective of R_{L}, the total voltage swing in +1/2V+, leading to a peak-to-peak magnitude of |V|.

### 4.Construction of the Tank Circuit Heater System

Assuming that the induction heater can accommodate the lower voltage swing, the advantage of the HHB switching system is that it halves the number of the active components such as FETs and driver electronics needed to sequence and control the switching voltages G₁ₓ. Moreover, ST is simplified as it only has to be managed between the two FETs as the capacitors passively prevent this happening. This leads to nearly halving both the BOM cost and the PCB space needed to accommodate the circuit, as the capacitors C₂₁ and C₂₂ are cheap to manufacture and buy, and have a small footprint, simplifying the control signals. Overall reliability increases with fewer active components and heat dissipation is reduced which further increases reliability and makes the system easier to incorporate into products.

Referring back to FIG. 1, the present inventors propose that the HHBs are suited to electrically exciting tank circuits. From FIG. 2, in response to the square wave characteristic of V_{sw} it is observed that a HHB gives rise to a relatively smooth, high quality sine wave output for Vₛₘₚₗ without discontinuities and negligible added noise both in and out of the resonance condition.

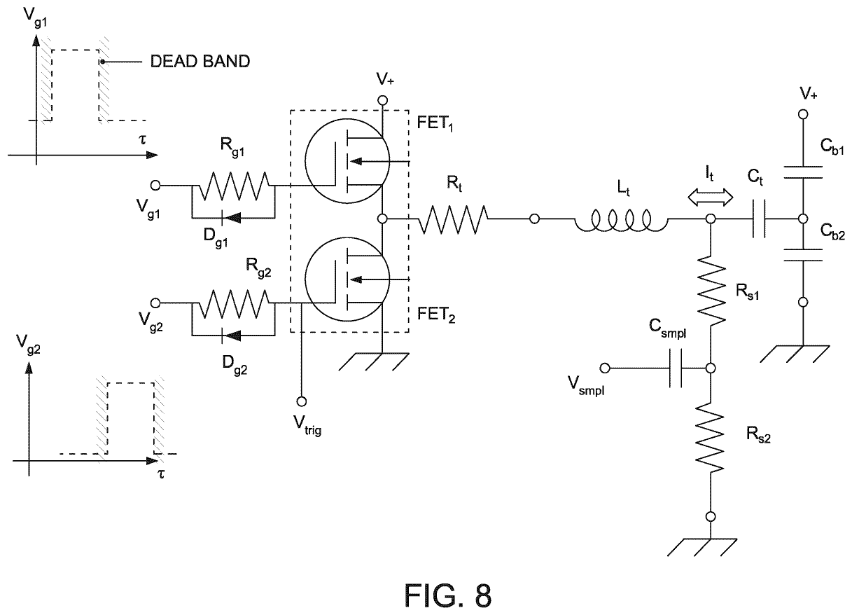

FIG. 8 shows the tank circuit with the sampling connection from FIG. 1 combined with the HHB from FIG. 7. As discussed previously, to set up an oscillation in the tank circuit, it is necessary to alternately trigger FET1 and FET2 by applying a gate voltage on V_{g1} and V_{g2} respectively. The left-hand side FIG. 8 shows characteristic waveforms for V_{g1} and V_{g2}, which are offset in time, but also there is a gap along the temporal axis between V_{g1} turning off and V_{g2} turning on and vice versa, termed as the dead band which prevents both FETs being momentarily in a low resistance state, allowing a large and often uncontrolled level of current to flow between V+ and GND through the FETs, usually termed as “shoot through” (http://www.irf.com/technical-info/appnotes/an-1032.pdf) which can be damaging to the circuit and the power source. For high-speed excitation of the tank circuit, the duration of the dead-band should be as low as possible. In this case the V_{g1} and V_{g2} will be generated and automatically synchronised by the TPS28226DR device (not shown) manufactured by Texas Instruments inc.

The gate drive voltages are then applied to the FETs via an input network comprising a parallel network of a Schottky diode (D_{gx}) and a low value (˜5Ω) resistor (R_{gx}). In this example, the resistor dampens the speed of the positive going edge to stop it ringing. Conversely, when the gate is turned off, the diode increases the rate at which charge is pulled out of the gate. Together, this addition improves the switching characteristics by damping the voltage oscillations (See Fundamentals of MOSFET and IGBT Gate Driver

Circuits, applications note SLUA618, page 19, www.ti.com/lit/slua618). This is due to the input gate of a FET acting as a capacitor that has to be charged/discharged in order to switch the transistor between a conducting/non-conducting state. Without this addition, gate charging can become erratic when the operating speed is high (in this case >1 MHZ), causing V_{gx} to oscillate, ultimately leading to erratic and noisy current flow in the tank circuit.

A number of different FETs were evaluated and it was found by the present inventors that the BUK9K5R1-30E device from Nexperia™ (https://www.nexperia.com/products/mosfets/automotive-mosfets/BUK9K5R1-30E.html) is an optimal device for forming the HHB. Using the BUK9K5R1-30E can switch on 40 amps of current from a 30V supply.

Additionally, the absolute value of the Vₛₘₚₗ (and by inference, V_{sw}) is not relevant as the analytical measurement depends on a differential method which excludes constant offsets. Nonetheless, for good practice, it is often useful to ensure that the system inputs are working correctly and so the circuit of FIG. 8 includes a monitoring output V_{trig}. Ideally this would be at the intersection of Rₜ/FET1/FET₂, but measurements taken by the present inventors showed that the waveform is heavily distorted at this point. Alternatively, taking advantage of the smoothness of V_{g2} after inclusion of the D_{g2}/R_{g2} network, it was decided that V_{trig} would be derived from a point between the input damping network and gate connection of FET₂.

5. Measurement and Control of System to Determine f_{Res} in Real Time

To determine the ERF in real time, methods according to embodiments of the invention employ the technique discussed in section 1 above: when f_{d}=1/(2π√(LₜCₜ))=fᵣₑₛ, the impedance |Zₜ| is minimised and |Iₜ| is maximised. This condition is detected via a Peak Detector Circuit (PDC) by measuring Vₛₘₚₗ which acts as a proxy for Iₜ. A PDC is an electronic device, that iteratively measures the peak voltage of a signal fed into it (tinyurl.com/6xhjynww).

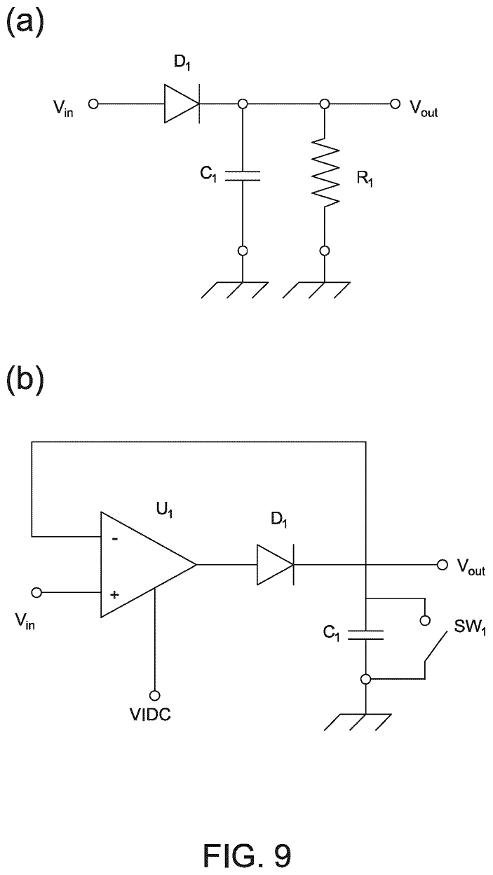

FIG. 9(a) shows a PDC comprising a diode (D1), a capacitor (C1) and a discharge resistor R₁. Starting with C₁ uncharged, any positive signal applied to Vᵢₙ will force current into C₁ via D₁ up to the point where the voltage across the capacitor equals the peak of Vᵢₙ. If Vᵢₙ is held at a constant level, then the voltage across C₁ will also maintain a constant level. Should Vᵢₙ drop to 0V, then after a period of time governed by the RC time constant of C₁ and R₁, the charge will drop to 0V, effectively re-setting for the next peak detection cycle. Iₜ should be noted that the circuit layout in FIG. 9(a) is equivalent to the input circuitry in the majority of Analogue to Digital Converters (ADC) incorporated into many microcontrollers. Advantageously, therefore, these systems could be turned into PDCs with just the addition of an external diode and an appropriately specified resistor.

In practice, the PDC circuit in FIG. 9(a) has a number of drawbacks centred on speed and flexibility. To tackle these, an alternative PDC circuit is shown in FIG. 9(b), where Vᵢₙ is buffered by U1, a unity-gain Op-Amp (OA) whose output passes through a diode D₁ and then charges a capacitor C₁. The use of an OA allows Vᵢₙ to be isolated from C₁ and the low output impedance allows fast charging of the capacitor, independent of the impedance of the circuit giving rise to Vᵢₙ.

Additionally, in the PDC circuit of FIG. 9(b), R₁ has been replaced by a switch whose impedance can be switched between ˜0 and ∞Ω, which allows all the charge flowing D₁ to be collected which reduces the time for Vₒᵤₜ to reach an equilibrium during the sample period. When the system needs to be reset to take a new reading, SW₁ can be closed, allowing C₁ to be completely discharged in a time scale of microseconds. With this arrangement, if the voltage to be sampled is applied to Vᵢₙ, after a period of time the voltage across the capacitor, Vₒᵤₜ is measured which represents the maximum value of Vᵢₙ over the sampling period. During this sampling process, it is good practice that Vᵢₙ is disconnected from Vₛₘₚₗ, in order that random fluctuations and noise do not add to Vₒᵤₜ whilst the sampling is taking place. This is achieved by adding a second control line (Vᵢₙ Disable Control—VIDC). For optimum reproducibility, the charge in C₁ should first be drained such that Vₒᵤₜ˜0V by closing switch SW₁. Then SW₁ is opened to allow the PDC to start sampling Vᵢ again. For maximum stability over time and ambient temperatures, the capacitor is preferably a stable ceramic capacitor such as the COG or NP0 and SW₁ is preferably a bipolar field effect transistor with low on resistance and a very high off resistance.

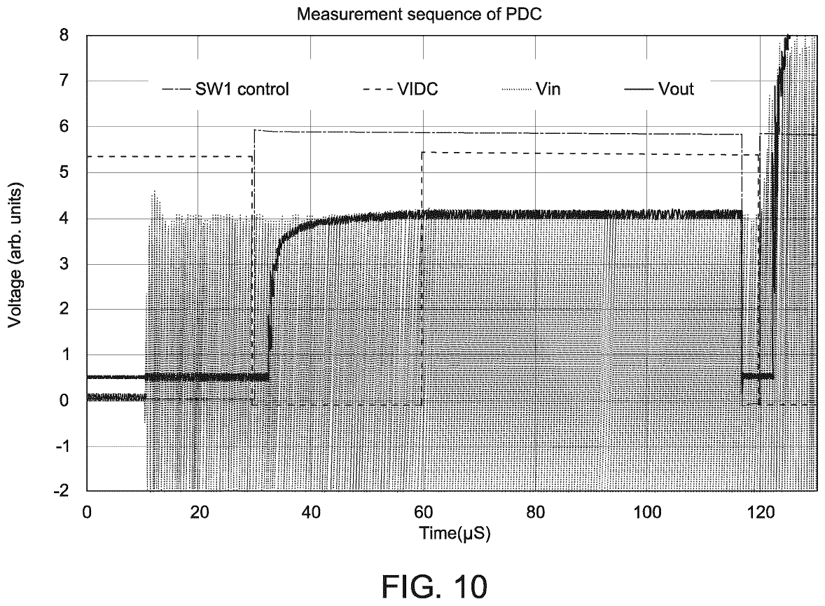

FIG. 10 shows the profile of one measurement cycle, illustrating the behaviour of the circuit in FIG. 9(b). The alternating voltage of Vₛₘₚₗ is driven near the ERF (fᵣₑₛ)_of ˜2.06 MHZ (Vᵢₙ, dotted line), the voltage across the capacitor (Vₒᵤₜ, solid line) and the discharge control voltage V_{sw} (dashed line) which sets SW₁ to open circuit when its voltage is set to zero. In order to use the PDC to find the amplitude of Vₛₘₚₗ the following four step approach may be adopted:

STEP 1—Charging of C₁: Referring to the times shown on the X-axis of FIG. 10, at t=30 μS SW₁ is set to open and VIDC is turned off, allowing charge to accumulate in C₁ from U1, controlled by the value of Vₛₘₚₗ applied to Vᵢₙ. As more pulses are applied to Vᵢₙ, Vₒᵤₜ rises progressively toward the limit imposed by the peak value of Vₛₘₚₗ. As this occurs, subsequent pulses give rise to a smaller increment than the previous. In practice, in embodiments according to the invention, Vₒᵤₜ reaches a semi-stable value after ˜60 pulses. To improve stability, the device may be programmed to deliver a fixed number of pulses once SW₁ is opened. Taking the previous values as a guide, 60 cycles are fed into the PDC, which give rise to a stable voltage at Vₒᵤₜ. To some degree, the use of a fixed number of pulses defines a reference baseline for collecting charge in to C₁. In an alternative embodiment, SW₁ is kept open and for a fixed time ignoring that Vᵢₙ is comprised of discrete pulses. The duration of this phase is 30 μS.

STEP 2—Measurement of Vₒᵤₜ: At t=60 μS the next step is to measure Vₒᵤₜ using an ADC (not shown). This device takes sequential readings of Vₒᵤₜ and stores them in memory. Better signal to noise ratio may be obtained when many samples are averaged. Prior to gathering the samples, in order to ensure stability of Vₒᵤₜ, VIDC is set to ‘on’ which prevents Vₛₘₚₗ being applied to Vᵢₙ. The duration of this phase is 42 μS.

STEP 3—Average the data and discharging sample capacitor. At t=102 μS the samples are summed in an accumulator. As the output of the ADC is a usually an integer, to speed up the averaging process, it is good practice to make the number of samples a power, P of 2 (e.g., 64, where P=6). This affords the opportunity to average the total by right shifting the binary number (toward the least significant bit) by P bits equivalent to dividing by 2″, which is processor efficient. During this period a signal is applied to switch SW₁, causing it to close, which in turn provides a path to ground for the charge stored in C₁. In practice, after ˜1 μS, Vₒᵤₜ has returned to a value close to 0V, at which point the PDC is ready to start measuring the next data point. The duration of this phase is 5 μS.

STEP 4—Setting next value of f_{d}: At t=107 μS, the next value for f_{d} is sent to the programmable clock oscillator causing it to generate a square wave at the new value via the HHB. Once the clock has stabilised the program reverts back to STEP 1. The total duration of this phase is ˜2 μS.

As previously discussed, to obtain a data set that allows an ERF (fᵣₑₛ) to be determined, a series of N amplitude-frequency averages have to be gathered to form a balanced series of Vₛₘₚₗ versus fa, with f_{d} stretching from below, through and above the ERF (fᵣₑₛ), with the latter being at roughly the half way point to help the LSA calculation. With this it is possible to gain an accurate value for the selected ERF (fᵣₑₛ) with N≈20, although this might change due to external factors. Overall, with 20 points, the process of determining an ERF (fᵣₑₛ) in this example be completed within a timescale of 6 ms. Advantageously, therefore, this technique can provide frequency tuning data which in turn can be used as a proxy for susceptor temperature during heating at >100 times/second.

In performing the scan of discrete frequencies, as the value of f_{d} gets closer to ERF (fᵣₑₛ), as Vₛₘₚₗ increases, this is caused by a corresponding amount of energy being stored in the tank circuit which has to be sourced from V_{sw}. As from above, the rate at which energy can be passed into/out of the tank circuit is governed (and limited) by its Q value. As the stepped frequency scanning process needs to be performed quickly over a timescale of <2 mS with the minimum of distortion to allow the tank circuit to fully equilibrate at each new frequency, it is useful to minimise the step in Vₛₘₚₗ. As the profile of the sample series is engineered to be roughly symmetric as illustrated in FIG. 3(b), the following method can be adopted.

Referring back to FIG. 3(b), if the first sample is taken at 2.045 MHz, the measurement process in FIG. 10 is carried out. From there, the second sample can be taken at 2.085 MHz, which nominally gives a Vₛₘₚₗ value roughly equal to that of 2.045 MHz, minimising the amount of charge/energy that needs to flow into tank circuit. The third value of f_{d} could either be 2.048 or 2.083 MHz, both of which will be closer in absolute terms to the derived ERF (fᵣₑₛ), and thus will give a small increase in Vₛₘₚₗ, requiring more energy to be transferred into the tank circuit, with the fourth being 2.083 or 2.048 MHz, either of which are energy neutral. This process may continue until it converges on the approximate position of ERF (fᵣₑₛ).

The sample readings measured during this process are then sorted into ascending frequency in the microprocessor and passed to the LSA for estimation of the current value of ERF (fᵣₑₛ). Over the 20-samples gathered during this process, Vₛₘₚₗ increases and thus energy only flows into the tank circuit. In an alternative embodiment, a similar algorithm could be used which starts at the prior selected ERF (fᵣₑₛ), the second ERF chosen to be a small increment above the prior selected ERF (fᵣₑₛ) and the third frequency a small increment below the prior selected ERF (fᵣₑₛ). Once a value of the ERF has been generated, the array of points can be populated either sequentially in frequency or sequentially in decreasing amplitude of the signal, as it either climbs down from the previous ERF peak or climbs up toward the current peak amplitude value. Over the remaining 17 steps, the current drawn from the power source will gradually reduce independent of whether the second ERF is above/below the starting selected ERF. Collectively, the embodiments of this stepping technique can be used to limit the rate of charge the power supply and circuit have to source/sink, which will increase the overall efficiency and reduce the electrical stress on the device, prolonging its life.

In contrast, if the 20 samples were acquired in simple linear frequency steps from below to above the ERF (fᵣₑₛ), the flow rate of energy into the tank circuit would be twice the above for the first 10 samples <fᵣₑₛ and would then be extracted at the same rate for the ˜10 steps >fᵣₑₛ, or vice versa. In both cases the energy needs to either be supplied or drained from the tank at twice the rate of the above method which could lead to distortions in the Vₛₘₚₗ VS. f_{d} data which would skew the value of the selected ERF (fᵣₑₛ) generated by the LSA calculation.

Iₜ should be noted that the technique chosen to compute an ERF (fᵣₑₛ), via the amplitude of Vₛₘₚₗ is made possible by the HHB generating a smooth and steady sine-wave characteristic for Iₜ, which is reflected in Vₛₘₚₗ, both on and off resonance. In particular, the inclusion of the R_{gx} and D_{gx} networks (i.e. damping resistor and turn-off diode) on the gate inputs of FET1 and FET₂ smooth out and prevent voltage spikes on Iₜ when V_{gx} changes state that coincides at or near the peak of Vₛₘₚₗ. Without these networks, these spikes would unduly perturb the value obtained from the PDC. Other driving circuit configurations may not produce such a clean signal as does the HHB with the get input networks and therefore the use of a PDC may not always be viable for alternative bridge architectures.

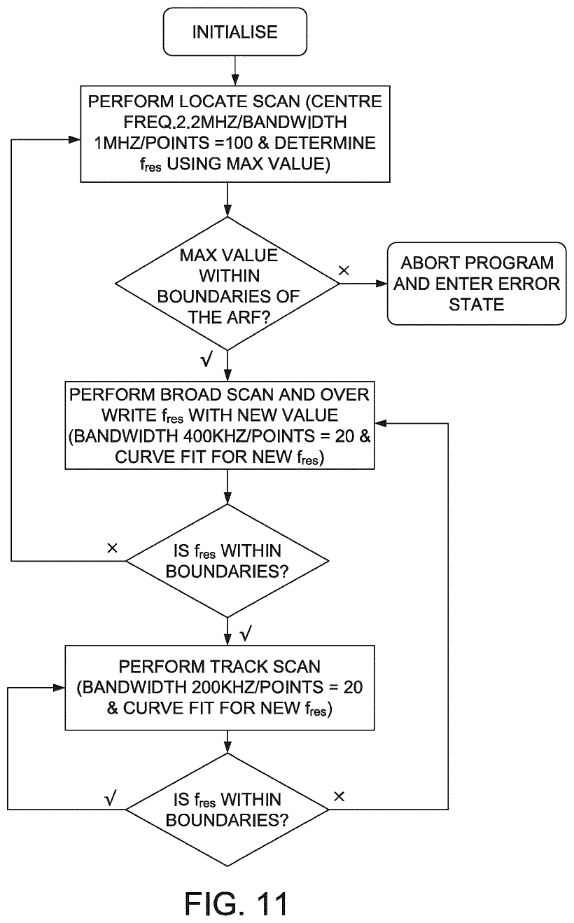

FIG. 11 is a flow diagram showing a control algorithm for a device according to an embodiment of the invention. When the device is turned on there will be an initial location scan of 100 samples over 1 MHz bandwidth to determine a ‘rough’ position of ARF. The sweep will be sufficiently broad that the value of ERF (fᵣₑₛ) can be determined by taking the maximum value, and using this, the system will store an upper and lower frequency within which ERF (fᵣₑₛ) should occur and if it's not the case, the system will abort the program and stop the device being used for safety reasons.

On the other hand, if the ERF value is within tolerance, a second sweep of 20 points is performed, termed as the ‘broad scan’ using the new ERF (fᵣₑₛ) value as the central point, with a bandwidth of 400 KHz. Again, the system will use a second set of frequency tolerances, finer than the previous to assess if the ERF is valid, if not, the system will revert to the 1 MHz bandwidth and repeat the previous step. Otherwise, the system will then perform a final ‘track scan’ (200 KHz bandwidth and 20 points) to get a useable derived ERF (fᵣₑₛ) which is passed to the temperature control system which can be either a thermostatic (on-off) device or a more sophisticated Proportional-Integral-Derivative Controller (PID-C) (https://en.wikipedia.org/wiki/PID_controller).

A common dilemma in measuring susceptor temperature via the heater system is that the measurement process will unavoidably increase the temperature from the nominal value, skewing the measurement. Therefore, it is necessary to minimise this effect. In operation, whilst the system is being heated, or maintaining a stable high temperature (>200° C.) the intrinsic heating effect of temperature determination can be considered to be less significant. On the other hand, for most of the time the heater is not turned on and, in these conditions, it is vital that the system is able to deliver a stable temperature reading under all conditions, so a detailed analysis is necessary.

From above the constituent steps, using the times illustrated in FIG. 10, the time taken to derive a value for fᵣₑₛ is composed of the following;

STEP 1: 30 μS-Open SW₁ to allow C₁ to charge to peak value of Vₛₘₚₗ

STEP 2: 42 μS-Take 64 ADC readings

STEP 3: 5 μS-Close SW₁ to reset C₁ and average results

STEP 4: 2 μS-Set oscillator clock to next value of fa

Total 79 μS

If N=20, the data points can be accumulated within 1.6 mS. Because the curve fitting algorithm via the LSA technique takes ˜6 mS to select the ERF (fᵣₑₛ) with a moderately specified, low-cost microcontroller, data gathering can be performed independently using Direct Memory Access (DMA) techniques in which case the overall the speed would be limited by the LSA algorithm.

In a practical heater system, the PID-C will often control the temperature profile by adjusting the power applied to the heater circuit using a Pulse Width Modulation (PWM) system (https://en.wikipedia.org/wiki/Pulse-width modulation). In this scheme the square wave excitation (V_{sw}) of the bridge electronics (˜2 MHZ) is in turn modulated by a second lower frequency square wave, f_{pwm}, where the Duty-Cycle (DC) of the peaks and troughs is adjustable between 0-100%, respectively corresponding to the heater being turned off and working at full power, with values in between acting as pseudo-analogue control of the heating process. With this, the PID-C can then control the heater to a finer degree than a simple binary (on-off) thermostatic control algorithm.

The choice of f_{pwm} is often driven by external considerations, one of which is the audible response of human hearing, which is often quoted as 20-20 KHz with a peak ˜3.5 KHz (https://en.wikipedia.org/wiki/Equal-loudness contour) with the sensitivity dropping off rapidly below 300 Hz and above 20 KHz. Iₜ is the case that if an electronic device is modulating a powerful current, then an audible sound is generated (e.g. ‘mains hum’) which can cause irritation to the user. As the time taken to gather 20 unique data points is ˜1.6 mS would not fit into the period if f_{pwm} >20 KHz, therefore in the following discussion the PWM timebase frequency will be set to ˜100 Hz, giving a period of 10 mS.

In an example, to create a temperature profile for a channel there are four distinct control phases:

PHASE #1: Idling at room temperature waiting for a session to be activated. In this phase, heating is not required, but it is important to monitor the ambient temperature in order to create a starting temperature when heating is activated. In this case the temperature readings can be performed every second. This could be achieved by reducing the time-base to 1 Hz and the duty cycle to 20%. In this way the overall heating duty cycle will be reduced to an average heater on-time to ˜0.16%, which will cause negligible heating.

PHASE #2: Heating the consumable to the working temperature. Here the user has installed a consumable in the susceptor and begun the heating cycle, where the aim is to get the system up to the working temperature as rapidly as possible. In this case the DC is often set ˜90-100%.

PHASE #3: Maintaining constant working temperature. Iₜ is normal that the max power of the heater is greater than is needed to maintain the highest working temperature, and thus the DC is reduced to 30-50%.

PHASE #4: Cooling down after end of session. The simplest method of achieving this would be to set the DC to 0%. In some cases, controlling the profile of the cooldown is desirable, but this still would demand lower DC values compared with PHASE #2 and #3. On completion of this phase the system will return to PHASE #1.

Of all the four phases, the most critical for the temperature measurement system is PHASE #2, where the rate of temperature increase is at its highest, thus it is necessary that the PWM and temperature determination is carefully integrated to allow close control during this phase without interfering with the rapid heating.

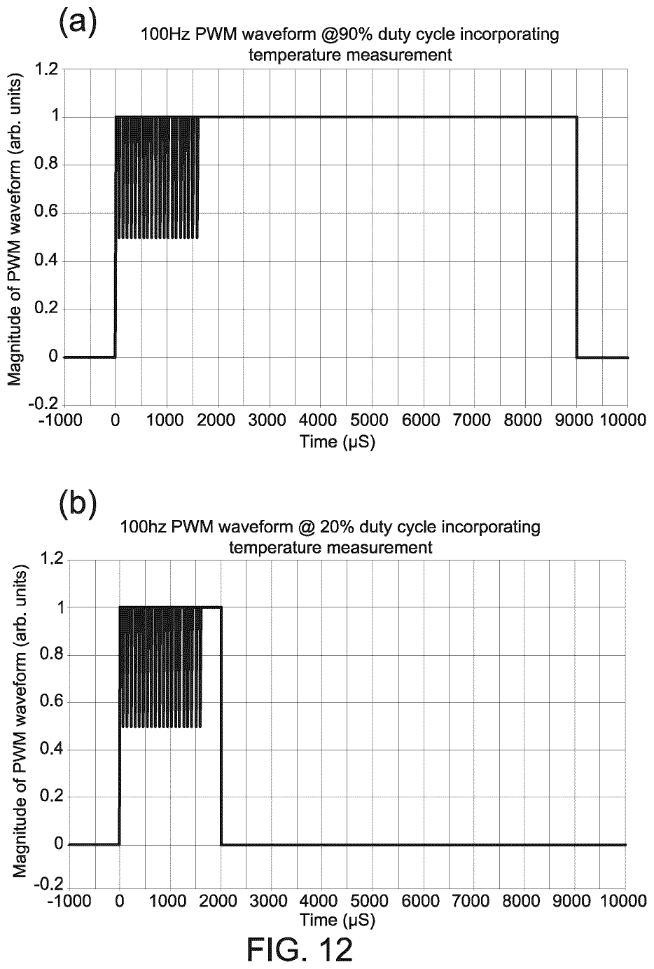

From above, because the susceptor 16 is heated during the temperature measurement method, it is pragmatic to combine the temperature measurement pulses into the leading edge of the PWM pulse. The plots of FIG. 12(a) shows a 100 Hz, 90% DC (9 mS on/1 mS off) PWM, with the acquisition of the frequency/temperature data integrated into the first 1.6 mS of the waveform. In PHASE #2, the data acquisition takes up the first 16% of the available duty cycle allowing the remaining 84% of the DC to be used for heating.

The plot of FIG. 12(b) shows that the PWM can comfortably accommodate the frequency/temperature determination down to a 20% DC, illustrating that this method can be used without compromise in all phases of heating and cooling. Moreover, using the 20 data points, the selected ERF (fᵣₑₛ) has to be evaluated using a microprocessor. Current test on a Microchip Inc. PIC32MX1 shows that this can be performed in ˜6 ms, which fits comfortably within the remaining 8.4 mS of the PWM cycle time. Overall, by using this format, the susceptor temperature can be estimated at a rate 100 Hz, in all phases of the device's operation.

### 6. Construction of a Practical External Susceptor for a Tubular Aerosol Consumable

From FIG. 4, the induction heating device as a high aspect ratio (length/diameter) cylindrical metallic foil susceptor 16 into which a similarly shaped object will be placed in order to be heated in controlled conditions. Forming a cylinder by using a rectangular piece of material and bonding along a straight edge is simple, but can be limited in strength, particularly for high aspect ratios. In contrast, if the same rectangular strip was wound helically, then the angle at which it is wound around the former will modify the overlap and thus the rigidity and overall strength. Iₜ is for this reason paper drinking straws are made this way, allowing the structure to be made using similar manufacturing techniques: see https://tinyurl.com/59dn883a as a guide.

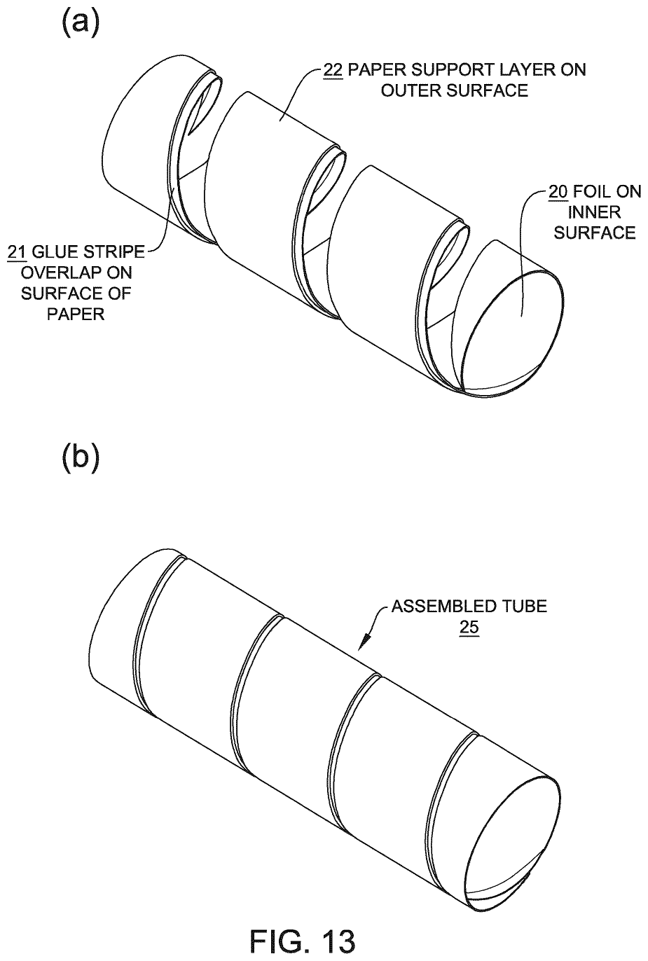

FIG. 13(a) shows the construction of a helical wound susceptor using a foil 20 bonded to heat resistant paper forming a laminate capable of withstanding temperatures up to 200° C. In this example, the foil is 12 μm thick. Similar materials are manufactured by a number of suppliers and in the present disclosure all the results were generated using the by Bacofoil™ product (UPC 5023139217700). To form the helical structure in this example, a strip of the material is cut and on one edge, a bead of glue 21 is deposited, which can either be on the foil or paper side 22 with the latter illustrated in FIG. 13(a). Then a cylindrical former is placed against the foil at >45° to the long edge of the strip, allowing the laminate to be wrapped tightly around the former resulting in a bonded rigid tube 25 as illustrated in FIG. 13(b) with the foil on the inner and paper on the outer surface. Using the angle of former rod relative to the edge of the strip of laminate, the pitch of the helix can be controlled which, in turn, will change the amount of overlap when assembled. Iₜ should be noted that at the overlap, there will be a double layer of foil, which will be electrically interactive with the magnetic field of the induction heater. If the foil thickness is less than the skin depth δ then the overlap could give rise to double heating which could be utilised to adjust the amount of heating in a consumable.

As stated previously, the consumable being heated by the susceptor according to preferred embodiments is cylindrical with the same diameter along its length. To optimise the transfer of heat between the inner foil layer of the susceptor and the outer surface of the consumable and workpiece should be pressed tightly together to provide an efficient thermal contact, facilitating the transfer of heat between the two. Moreover, by definition the consumable should be able to be removed from the susceptor. As both parts (i.e. the susceptor and the consumable) are of a cylindrical form, a way of achieving this is to make the susceptor slightly conical such that, as the consumable is inserted into the susceptor, the consumable will begin to make contact against the inner wall of the susceptor. When the consumable is pushed fully inside the susceptor, the lower half of the consumable will be in contact with the susceptor, giving good thermal contact between the two elements. In practice, the internal cone angle needed to achieve this is only a few degrees) (˜1-10°, and can be achieved with the construction method outlined above, along with a conical former instead of one with a constant diameter cylindrical profile.

Because the susceptor has the foil on the inner surface of the cylinder, the inductive heating will only occur within the foil layer, which is, in turn, in tight thermal contact with the outer layer of the consumable. As such the paper that comprises the outer layer of the laminate does not play a significant role in the heat transfer process allowing the paper thickness to have relatively wide range and be made of a variety of materials, although it should be capable of being heated >200° C. without damage. In some applications, if the paper was made thicker, it could increase the foil-consumable heat transfer efficiency, by preventing parasitic losses to the environment at high temperatures.

### 7. Relating Susceptor Temperature to the Shift in Resonant Frequency

A method for measuring the ERF of a tank circuit where the underlying values of the resistance, inductance and capacitance are changing due to external parameters was described in the sections above. Aspects of the present invention relate this change to the temperature of the foil susceptor 16 shown in FIG. 5, when this assembly replaces Lₜ in FIG. 1 to form the circuit whose schematic is shown in FIG. 6.

Assuming that the rolled foil acts as a single turn secondary coil, L_{sec} of a magnetically coupled transformer, the current flowing in Lₚᵣᵢₘ will induce a current to flow in L_{sec}. As it flows around the circumference of the foil, electrical energy will be converted to heat and the temperature will rise within the area magnetically coupled to the oscillating magnetic field generated by Lₚᵣᵢₘ. As this happens, two effects occur:
i) Because the heating increases the volume resistance of the metal, defined as p (https://en.wikipedia.org/wiki/Electrical resistivity_and_conductivity #Metals) the electrical (Ohmic) resistance of the foil will increase, giving rise to increased losses that change the energy transported from the primary circuit to the susceptor.
ii) Additionally, the increase in p increases the skin depth δ (see above). If the foil thickness is >δ, then this has little effect on the overall system. In contrast, if δ is >than the foil thickness, the magnetic field generated by the coil will penetrate the foil, leading to a weaker interaction between the two, which in turn changes the response of the frequency shift.

Collectively these two effects will affect the values of Z_{sec} such that the ERF (fᵣₑₛ) is changed sufficiently such that it can be measured by methods according to the present invention. In order to illustrate this, a foil tube integrated into a tank circuit as illustrated in FIGS. 5 and 6 had temperature-controlled air blown along its axis. Then using the method described above, ERF (fᵣₑₛ) was found for a series of temperatures between 25 to 200° C.

The core of the measurement circuit was a series LCR circuit comprising a 22nf C0G ceramic capacitor and a 4.5 turn copper coil; the susceptor was a 7.5 mm inner diameter helical coil of the foil-paper laminate described above with a small overlap of a couple of millimetres along its length, with the foil on the inside surface as illustrated in FIG. 13(b) mounted coaxially within the induction coil. As the paper on the outer surface has a relatively high emissivity, this allows its temperature to be measured during heating using an Infra-Red Camera, (IRC) which in this example is a FLIR ETS320 running the FLIR Tools PC software package. Advantageously, in this application the IRC provides a complementary non-contact/passive technique that to first order does not change thermal load to the susceptor as would a wired temperature sensor such as a thermocouple or thermistor.

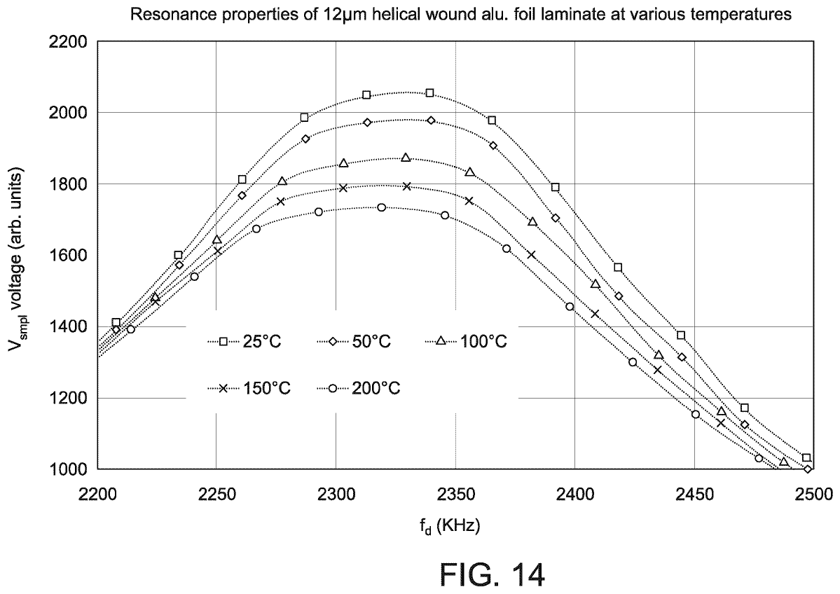

FIG. 14 shows the comparative resonance profiles for 5 discrete temperatures (25, 50, 100, 150 and 200° C.) obtained by scanning the value of f_{d} and measuring Vₛₘₚₗ via the PDC for each value of fa. From these results, two distinct features are apparent from the data;
i) The frequency of the peak value, which by definition corresponds to ERF (fᵣₑₛ), shifts down in frequency by 14 KHz at 200° C. relative to room temperature, corresponding to a ˜0.7% reduction over the range. This is indicated by the leading edges of the five data sets bunching together on the right-hand side of the plot of FIG. 14.
ii) Secondly, the height of the of peak drops as the temperature of the susceptor is increased, giving a 15% reduction in peak height, over the 175° C. temperature range. The drop appears to be monotonic and progressive as the samples are heated.

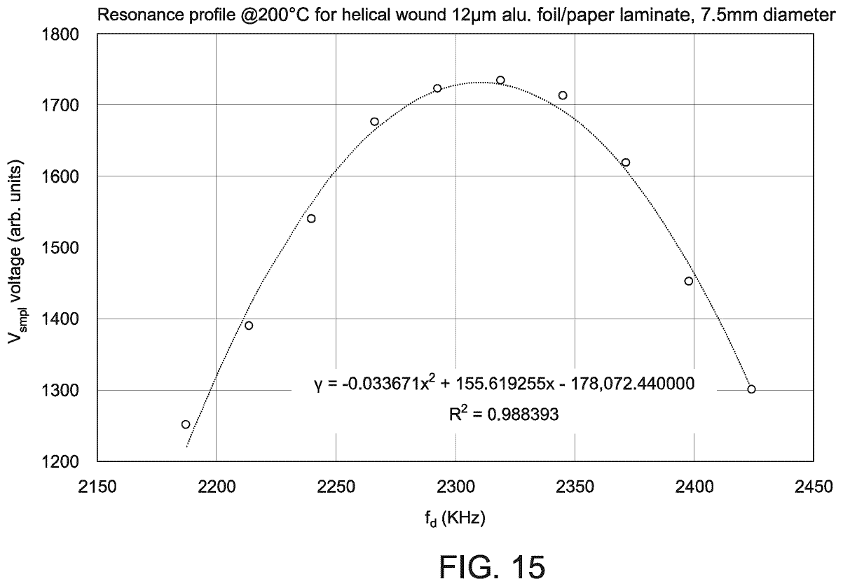

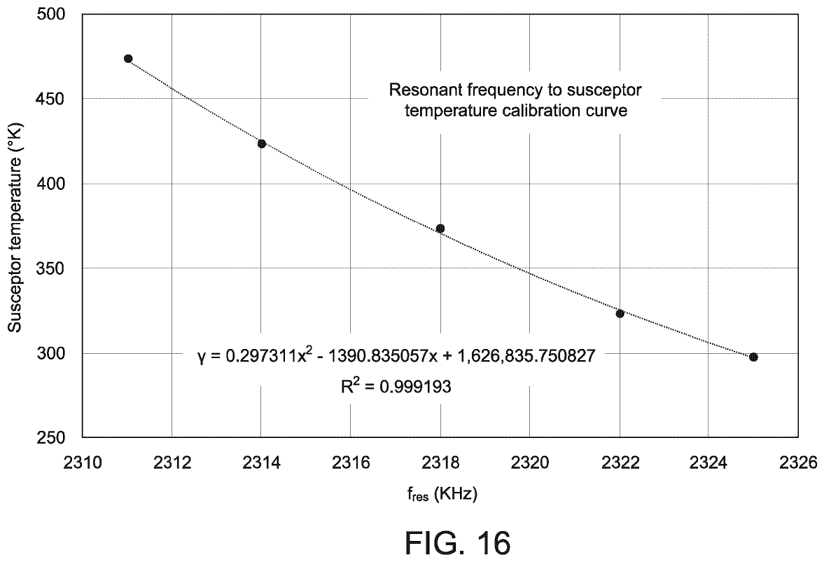

FIG. 15 shows a more detailed profile of the 200° C. curve shown in FIG. 14. Using this data, a second order polynomial least squares fit was performed, represented by the superimposed dotted line, whose coefficients are shown at the bottom of the panel. By using the method outlined in section 1, Eq. 6, ERF (fᵣₑₛ) is calculated to be 2311 KHz. Collating the results, the quadratic fit parameters of the five curves was carried out; FIG. 16 shows the calculated value of the foil temperature as a function of the estimated resonant frequency (ERF) of the system. Over the five data points generated, fitting a second order polynomial regression gives a CD of >0.999 and over the range presented, the approximate linear shift corresponds to ˜0.013° K/Hz shift in ERF (fᵣₑₛ) indicating that over the temperature range, ERF. (fᵣₑₛ) will drop ˜800 Hz, for every 10° K shift up in temperature. In summary, the results show that over this temperature range using the materials, equipment and methodology detailed above, the temperature of the 12 μm foil can be measured via the heating system using the value of the ERF.

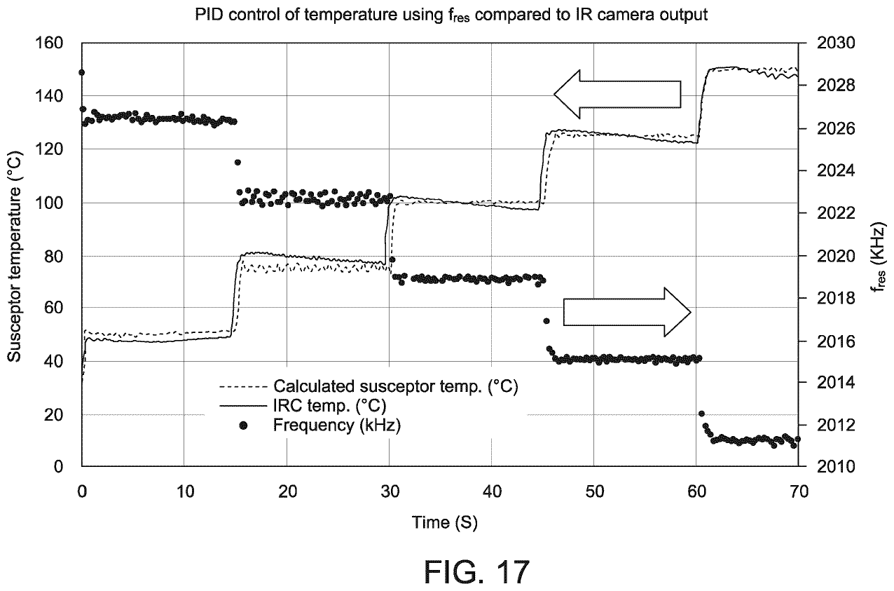

FIG. 17 illustrates how such a parametric fit can be used for closed-loop control of the temperature profile in an induction heater. In this case, a cylindrical susceptor with a simple axial (non-helical) overlap, 7.5 mm in diameter composed of the foil-paper laminate discussed above was paired with a 3-turn excitation coil of the form shown in FIG. 5. Subsequently the combination had its temperature-frequency response characterised by passing heated air at various temperatures down the axis of the susceptor. After giving the system sufficient time to equilibrate, the external surface temperature was measured using an IRC at a number of fixed temperatures. Then the fitting and parameterisation was performed as outlined in FIGS. 14, 15 and 16 and the associated description, to derive the relationship of IRC temperature vs. the frequency response of the induction heater/susceptor combination.

The susceptor was then inductively heated by exciting the HHB using with a PWM waveform at a 100 Hz frequency that is, in turn, controlled via a PID-C method for modulating the power of the heater. As illustrated in FIG. 12, as the leading edge of each pulse comprising the PWM signal incorporates the 20 values of swept frequency impulses used to measure ERF (fᵣₑₛ), the temperature is also monitored at 100 Hz.

FIG. 17 shows three plots:
The behaviour of ERF (fᵣₑₛ) during the heating cycle (dotted line);
The calculated susceptor temperature (dashed line);
The temperature measured independently using the IRC (solid line);

The temperature was increased and controlled using the instantaneous measured value of ERF (fᵣₑₛ), converted to a foil temperature and the profile stabilised at 5 elevated levels: 50, 75, 100, 125 and 150° C. for 15 seconds.

It can be seen from FIG. 17 that the PID-C keeps the value of the ERF (fᵣₑₛ), and by inference the calculated value of the susceptor temperature stable. Thus, to be able to measure the performance of the closed temperature control loop, the variance in the output of the IRC is analysed as the independent (external) variable. For the five temperature plateaus the following values were obtained at times 7.5,22.5, 37.5, 52.5 and 67.5 seconds respectively:

| Calculated susceptor | |
|---|---|
| temperature (° C.) | Measured IRC Temperature (° C.) |
| 50.3 ± 0.0 | 47.20 ± 0.04 |
| 74.9 ± 0.9 | 79.0 ± 0.40 |
| 100.0 ± 0.3 | 99.64 ± 0.22 |
| 125.0 ± 0.4 | 125.39 ± 0.22 |
| 149.9 ± 0.7 | 147.45 ± 0.59 |

The IRC readings show that the method according to embodiments of the present invention is able to stabilise the susceptor temperature to <+1° C. relative and within +3° C. absolute at the working temperature of the device (>150° C.) which is sufficient for it to be used in generating and controlling inhalable aerosols.

### 9. Relating Susceptor Temperature to the Change in Electrical Resistance

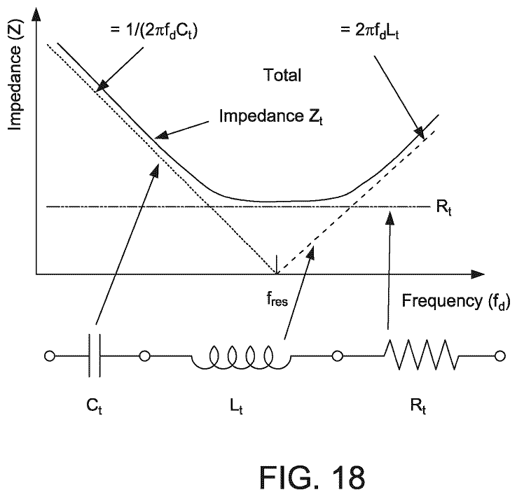

From FIG. 14 the data gave rise to a drop in the amplitude of the peak as the foil temperature increases. FIG. 18 illustrates the origin of the peak voltage in a simple series tank circuit near resonance and how this is related to the circuit's resistance (see industrial.panasonic.com/ww/ss/technical/n3 for more details). At ERF (fᵣₑₛ) the reactive components of the capacitor and inductor cancel out, leaving only the intrinsic, Ohmic resistance of the circuit as the circuit's impedance. On either side of the resonance, the residual reactive component begins to increase, thus the peak amplitude of the resonance profile is largely determined by Rₜ. In the transition region where the magnitude of the reactive and Ohmic impedances are equivalent to Rₜ, the impedance begins to follow the behaviour of the reactive impedances, leading to a flattened plateau-like feature.

From FIG. 18 the value of the Rₜ can defined as measure of impedance at fᵣₑₛ and as Zi (=Rₜ) increases, the peak amplitude shifts to a lower value. Using the equation shown in FIG. 15, if the value of ERF (fᵣₑₛ) is back substituted then a value for the amplitude corresponding to the admittance of the tank circuit Zt. As the induction heating device is formed as a transformer, with a primary driving circuit (p) and secondary foil susceptor(s) in, or around the consumable, then from appendix A below, Zₜ=Zₚ+Zₛ, where Zₛ is the impedance of the foil. Moreover, at ERF (fᵣₑₛ), Zₛ has no reactive element and is equivalent to the Ohmic resistance of the foil. Thus, as the susceptor is heated, the resistance of the foil will increase due to the temperature coefficient of resistance, p of aluminium (=0.43%° K⁻¹), increasing Zₛ which in turn reduces Iₜ (and Vₛₘₚₗ).

Referring back to FIG. 14, the resonance profiles for higher temperatures exhibit a progressive reduction in their peak voltage and, using the method of locating ERF (fᵣₑₛ) described above, ERF (fᵣₑₛ) is then back substituted into the polynomial of the form shown in FIG. 15.

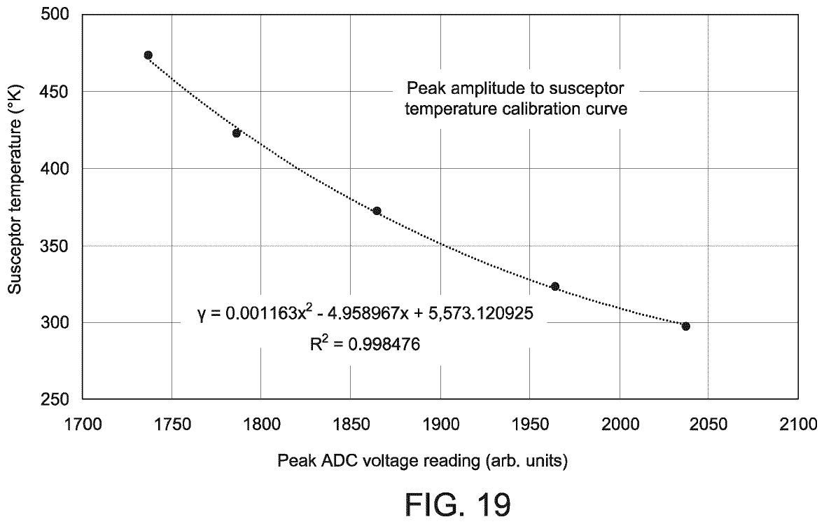

FIG. 19 shows the peak amplitude of the data from FIG. 14, plotted against temperature, along with a polynomial fit given by the equation shown in FIG. 19, with a CD >0.99 and allows the susceptor temperature to be determined by measuring the peak amplitude of the resonance curve, which can then be used as the measured variable in a closed loop control algorithm as shown in FIG. 17.

From a different viewpoint, because the change in resistance from this method over the temperature range is ˜15%, rather than ˜1% for the frequency data plotted in FIG. 16, this parameter may well enable a more fine-grained determination of the susceptor temperature due to its larger variation over the temperature range defined here. Moreover, because it relies on locating the peak of a relatively flat-topped curve, simpler methods of finding the peak than the LSA algorithm could be used, such as taking the voltage data for the plateau and using a simple sort algorithm to locate the peak value and taking this as the peak amplitude. A more sophisticated algorithm could be used where the top value and a number of neighbouring points are averaged, in case the single highest points in the data set is due to noise.

As stated above, the determination of the frequency is independent of the amplitude of V_{sw}. This is not the case for the voltage steps shown in FIG. 14, as it uses the value of Vₛₘₚₗ, which is directly related to V_{sw}. Thus, the voltage of the battery should be taken at the same time as each reading of the PDC and the value of the latter normalised by the former in order to produce a dimensionless constant where the PDC output is expressed as a fraction of the battery voltage.

As stated above, the measurement of frequency shifts becomes more difficult for thicker foils for a number of reasons. In contrast, the resistance-based method according to embodiments of the invention advantageously works on aluminium foils which are multiple skin depths thick and on most common metals such as nickel, steel (inc. stainless) etc. with a thickness >10X the skin depth at 2 MHz.

### 10. Benefits of the Methodology in Practical Induction Heating Systems

Using the methods according to aspects of the invention for detecting and quantifying shifts in ERF and/or response amplitude, an induction heater device will be able to simultaneously heat the susceptor and detect the temperature it has reached through the heater circuitry, dispensing with the need for external sensors such as thermocouples or thermistors. This gives a number of advantages, as mounting discrete sensors on the susceptor has drawbacks, such as:
The physical size and heat capacity of the sensor can perturb the readout temperature as the foil onto which it is bonded is only a few microns thick;
Bonding a discrete sensor onto a 10 μm foil is a difficult process as the foil will tend to tear if any mechanical load is applied via the sensor leads;
If welding is used care has to be taken to weaken and/or oxidise the metallic susceptor, possibly damaging the susceptor material;
If glue is used, it should not add thermal mass and/or thermally impede the passage of heat from susceptor to the sensor.
By definition, the sensor will need to be placed where the magnetic field generated by the coil is most intense. Thus, during its lifetime, it will be subjected to rapid thermal shock with a temperature delta of >200° Celsius, many thousands of times which will tend to degrade its performance, possibly leading to the sensor or its thermal bond failing, either of which will render the device inoperative.
From the latter, the electronics of the sensor will be subject to large currents being induced by the strong magnetic field, which could be problematic for the sensor or the electronics used to read it.

An advantage of adopting the frequency/amplitude temperature tuning system is that the induction system is always running near the actual resonance frequency (ARF) during all use cases; from the device idling as it waits to be activated, to when it is being aggressively heated as it nears the working temperature. Without the optimisation system according to aspects of the invention, if the device was tuned to an ERF (fᵣₑₛ) at room temperature, from FIG. 2(a) Iₜ would be maximised and synchronised to V_{sw}, optimising the amount of heating generated in Rₜ and minimising the losses in the primary circuit. Once activated, as the system heats to its working temperature of ˜200° C., the data presented in FIG. 14 shows the ERF (fᵣₑₛ) would move sufficiently for f_{d} to not coincide, giving rise to the characteristics shown in FIG. 2(c) where f_{d} >fᵣₑₛ, such that Iₜ is lagging and V_{sw} is reduced in amplitude, leading to less heat being dissipated in the susceptor and more by the coil and electronics that comprise the primary driving circuit. By using the system according to aspects of the invention, making a real-time estimate of the actual resonant frequency (ARF) and then adjusting f_{d} accordingly, means the system is always working as near to its optimum energy transfer efficiency, prolonging both the battery and the overall service life of the device.

In contrast to prior art methods which rely on directly measuring the ERF (fᵣₑₛ) of the tank circuit using an external signal, and then looking at the response of the circuit using digital counters to accumulate pulses over a fixed period, or interval timers measure the gap between individual pulses, methods according to the invention can measure ˜20 DC values, each of which has been generated in response to an external programmable clock signal, independent of the induction heater electronics, or the tank circuit. The data points are then mathematically analysed to generate an estimate for the system's resonant frequency. As such, methods according to embodiments of the invention are distinguished from many of the previous approaches.

The methods according to the invention cannot directly measure the Actual Resonant Frequency (ARF), they can only estimate it, for the following reasons;
Intrinsically the least squares approximation approach cannot generate an exact value for ARF from a set of data, as its name suggests. For example, the technique will take 10 data points, which are then used to generate a value that best represents the ERF (fᵣₑₛ), almost always different to any of the 10 gathered readings.
Secondly, the measurement process slightly heats the susceptor as the data points are gathered, so the susceptor will be slightly warmer when the 10th point is measured, relative to the 1^{st}. This effect will cause a slight skew in the data input to the LSA algorithm which will lead to a systematic perturbation in the estimation. This effect can be minimised by using as few pulses as is necessary on the fastest possible time base to generate the final voltage level on the PDC.

### 11. Use of the Temperature Sensing System in Alternative Heater Layouts

Th description above relates to sensing and control of temperature in a coaxial induction heating system, using a helical primary coil and a hollow foil susceptor. As the method is derived from general properties of an induction heater system, it will be appreciated that the method is applicable to many other induction heater geometries, some of which are exemplified below:

Flat excitation coil/plate susceptors: The structure and operation of domestic induction cooking hobs is well documented in the art. In this application, the coil is configured as a planar (flat) multiturn spiral separated by a sheet of glass or ceramic from the planar base of the cooking pan which acts as the susceptor. When the two are brought in close proximity, good coupling of the magnetic field into the base of the pan is achieved, facilitating efficient energy transfer. Due to the rapid growth in the use of induction cooking, there have been a number of attempts to devise a non-contact temperature measurement method using the change in the impedance of the induction heater circuit driven by the changes in the susceptor as the latter heats and cools. An example is discussed in Franco et al (https://doi.org/10.1109/JSEN.2011.2167226) which uses a second inductive coil in addition to the heater coil to ‘probe’ the impedance of the planar pan base, where the measured frequency characteristics are then used as a proxy temperature of the base. As the system according to embodiments of the invention detects this change by periodically re-purposing the induction heater coil as an exciter probe in order to measure the system's frequency, it obviates the need for a dedicated sensor coil.

As the systems in Franco et al measure the same parameter (system frequency) as proxy for the susceptor's temperature albeit using different apparatus, methods according to the invention will also be applicable to systems consisting of a planer (flat) induction coil exciting (e.g. heating) a planar (flat) susceptor. In these instances, the susceptor could range from thin metal foils to thick metals plates, ranging from magnetically inert aluminium to ferromagnetic elements and alloys therein.

Forms of compatible susceptors: For induction heating to be viable, a conducting metal body has to intercept a finite quantity of the magnetic flux generated by the induction heater coil. Moreover, for efficient coupling/energy transfer between the two, the susceptor should be able to intercept the majority of the flux generated by the action of Iₚᵣᵢₘ. As the oscillating magnetic field only penetrates the outer surface of an electrically conductive solid by an amount determined by the skin depth, δ, any interaction with material at a depth >δ is insignificant. Thus, if the tubular foil susceptor shown in FIG. 5 was made of aluminium foil with a thickness of 60 μm and the system was excited with Iₚᵣᵢₘ at 2 MHz, virtually all the energy would be absorbed by the susceptor. If the foil susceptor was replaced with a solid rod of aluminium with the same diameter, the amount of energy absorbed would be approximately the same, but due the added thermal mass the rod would heat more slowly.

In preferred embodiments, a viable susceptor structure satisfies the following criteria:
A: Iₜ is electrically conductive, within the range found in metals and semiconductors;
B: Iₜ intercepts the majority of the available magnetic flux;
C: Iₜ has the lowest possible thermal mass to maximise rate of temperature rise.

Accordingly, the susceptor can be any cross-sectional shape such as a rod, tube, cone, wedge, sphere, cube, longitudinal plate or any modified versions of the aforementioned.

Moreover, as long as the electrical criteria listed above (A and B) are met, the method of determining the temperature by using the system's resonant frequency as a proxy measurement can be carried with these types of susceptor.

1. A method comprising:
(a) providing an LCR circuit comprising an inductive element and a capacitor; and
(b) applying a voltage to the LCR circuit, wherein the applied voltage induces a response between the capacitor and the inductive element of the LCR circuit;
(c) generating an output signal of the response; and
(d) selecting a value that is representing an Estimated Resonant Frequency (ERF) based on the output signal;
the method further comprising:
(e) setting the frequency of the applied voltage to the Estimated Resonant Frequency in step (d); and
(f) repeating steps (b) to (e).

2. A method according to claim 1, wherein the output signal comprises a voltage signal, the method further comprising determining a maximum value for the voltage signal, wherein the Estimated Resonant Frequency is selected to correspond to the determined maximum value.

3. A method according to claim 1 or claim 2, wherein the step of determining a maximum value comprises fitting a polynomial function to the output signal data.

4. A method according to claim 3, further comprising minimising an order of the polynomial function using a Coefficient of Determination.

5. A method according to claim 3, wherein determining a maximum value comprises using a Least Squares Approximation method.

6. A method according to claim 1, wherein the steps are repeated in a second iteration, setting the frequency to a value above the Estimated Resonant Frequency from a first iteration of steps (a) to (e) being repeated in claim 1 and, when the steps of claim 1 are repeated in a third iteration, setting the frequency to a value below the Estimated Resonant Frequency from the first iteration.

7. A method according to any one of the preceding claims, wherein a peak detector circuit, PDC, is used to select an Estimated Resonant Frequency, the PDC comprising a PDC capacitor, the method further comprising the steps of:
charging the PDC capacitor during a sample time period;
measuring a plurality of voltages comprises in the output signal, and calculating an average value of the plurality of voltages over the sample time period;
discharging the PDC capacitor; and
setting the frequency of the applied voltage to the Estimated Resonant Frequency.

8. A method according to any one of the preceding claims, further comprising inductively heating a susceptor using the inductive element, to aerosolise a substance in a heating mode of operation.

9. A method according to any one of the preceding claims, wherein the output signal is used to provide a temperature measurement for the susceptor.

10. A method according to claim 9, wherein providing a temperature measurement comprises determining the electrical resistance of the susceptor.

11. A method according to claim 1, the method further comprising determining a maximum value of the Estimated Resonant Frequency, and, if the maximum value of the Estimated Resonant Frequency is within a predetermined range, setting the frequency of the applied impulse to the maximum value.

12. A method according to claim 11, further comprises repeating the steps of claim 11 until the set frequency is within the predetermined range.

13. A method according to any one of the preceding claims, further comprising determining a change in the Estimated Resonant Frequency.

14. A method according to any one of the preceding claims wherein selecting the Estimated Resonant Frequency comprises determining a change in the circuit resistance, the method further comprising determining a susceptor temperature.

15. A method of controlling the temperature of a susceptor comprising a method according to any one of the preceding claims.

16. A system comprising a voltage generator for applying a voltage to an LCR circuit, the LCR circuit comprising an inductive element and a capacitor, wherein the applied voltage induces a response between the capacitor and the inductive element of the LCR circuit, the system further comprising an output circuit for generating an output signal of the response;
and a processor for:
(g) selecting a value that is representing an Estimated Resonant Frequency based on the output signal;
(h) setting the frequency of the applied voltage to the Estimated Resonant Frequency (ERF) based on step (g); and
(i) repeating steps (g) to (h).

17. A system according to claim 16, wherein the voltage generator comprises a switching arrangement for generating impulses by switching between positive and negative voltage sources.

18. A system according to claim 17, wherein the switching arrangement comprises a H-bridge.

19. A system according to claim 18, wherein the H-bridge is a half H-bridge, HHB.

20. A system according to any of claims 17 to 19, wherein the voltage generator comprises a resistor and a diode.

21. A system according to any of claims 17 to 20, wherein the inductive element comprises a flat strip conductor.

22. A system according to any of claims 17 to 20, further comprising a susceptor heatable by the inductive element.

23. A system according to claim 22, wherein the susceptor is helical wound.

24. A system according to claim 22 or claim 24, wherein the susceptor forms a cone.

25. A system according to any of claims 22 to 24, further comprising an electrical connection around the susceptor.

26. A system according to claim 25, wherein the electrical connection is formed by a capacitor.

27. A system according to any of claims 16 to 26, further comprising a peak detector circuit, PDC, for determining a voltage maximum value from a plurality of voltages in the output signal.

28. A system according to claim 27, wherein the PDC comprises a unity-gain Op-Amp, OA.

29. A system according to claim 27 or claim 28, wherein the PDC comprises a switch having an impedance switchable between ˜0 and 02.

30. A system according to claim 27 or claim 28, wherein the PDC comprises a ceramic capacitor.

31. A system according to claim 30, wherein the ceramic capacitor is made of COG/NPO material.

32. A system according to claim 27 to claim 31, wherein the PDC comprises a bipolar field effect transistor.

33. A system according to any one of claims 16 to 32, further comprising a current sensor for measuring a current passing through the inductive element.

34. A system according to any one of claims 16 to 32, further comprising a control module for determining a performance of the system based on the output signal.

35. Computer-readable instructions which, when executed by a computing apparatus, cause the computing apparatus to perform the method as described according to any one of claims 1 to 15.

36. An aerosol provision system for generating aerosol from an aerosolisable material, the aerosol provision system comprising a system according to any one of claims 16 to 34, wherein the aerosol provision system is configured to perform an action in response to receiving an output signal from the output circuit.
